(19) United States
(12) Patent Application Publication
(10) Pub. No.: US 2024/0257676 A1
(43) Pub. Date: Aug. 1, 2024

(54) SIMULTANEOUS COLOR HOLOGRAPHY

(71) Applicant: Meta Platforms Technologies, LLC, Menlo Park, CA (US)

(72) Inventors: Nathan MATSUDA, Seattle, WA (US); Grace Elizabeth KUO, Seattle, WA (US); Florian Andreas SCHIFFERS, Brooklyn, NY (US); Oliver Strider COSSAIRT, Seattle, WA (US); Eric MARKLEY, Emeryville, CA (US)

(73) Assignee: Meta Platforms Technologies, LLC, Menlo Park, CA (US)

(21) Appl. No.: 18/421,662

(22) Filed: Jan. 24, 2024

Related U.S. Application Data
(60) Provisional application No. 63/441,140, filed on Jan. 25, 2023.
(60) Provisional application No. 63/441,534, filed on Jan. 27, 2023.
(60) Provisional application No. 63/445,918, filed on Feb. 15, 2023.
(60) Provisional application No. 63/441,532, filed on Jan. 27, 2023.

(51) Int. Cl. G09G 3/00; G03H 1/00; G09G 3/34

(52) U.S. Cl. CPC G09G 3/003; G03H 1/0005; G09G 3/34; G03H 2001/0088; G09G 2320/02

(57) ABSTRACT

According to examples, a computing system may include a processor and a memory on which is stored machine-readable instructions that when executed by the processor, cause the processor to use an optical propagation model and perceptual loss function to match an output of a spatial light modulator (SLM) based holographic display to that of a target image, wherein an input illumination into the SLM includes three simultaneous human-visible wavelengths of light. Through the simultaneous input of three human-visible wavelengths of light into a common SLM, the need for spatial or temporal multiplexing of three colors may be eliminated, which may improve a display's viability in terms of form factor and/or refresh rate.

### PRIORITY

This patent application claims priority to U.S. Provisional Patent Application No. 63/441,140, entitled “Simultaneous Color Holography,” filed on Jan. 25, 2023, U.S. Provisional Patent Application No. 63/441,534, entitled “Optical Lens Assembly with Integrated Electro-optical Subsystems,” filed on Jan. 27, 2023, U.S. Provisional Patent Application No. 63/445,918, entitled “Flexible Conductive Polymer Composites,” filed on Feb. 15, 2023, and U.S. Provisional Patent Application No. 63/441,532, entitled “Identification of Wearable Device Locations,” filed on Jan. 27, 2023, the disclosures of which are hereby incorporated by reference in their entireties.

### TECHNICAL FIELD

This patent application relates generally to holographic displays. Particularly, this patent application relates to holographic displays in which three human-visible wavelengths of light are simultaneously outputted for a holographic display of an image. This patent application also relates generally to optical lenses, and specifically, to an optical lens assembly with integrated an electro-optical subsystem layer. This patent application relates generally to flexible and stretchable electrically conductive composites. Particularly, this patent application relates to composites that include conductive polymer units and nonconductive polymer units, in which the conductive polymer units and the nonconductive polymer units are configured, positioned, and oriented according to predetermined arrangements in the composites. The predetermined arrangements may cause an electrical conduction level of the composites to vary progressively or proportionally to amounts of external mechanical stimuli applied on the composites. This patent application relates generally to wearable devices, such as wearable eyewear and smartglasses. Particularly, this patent application relates to the identification of estimated locations at which media are captured by the wearable devices to enable the captured media to be geotagged.

### BACKGROUND

With recent advances in technology, prevalence and proliferation of content creation and delivery have increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, service providers have endeavored to provide various forms of wearable display systems. One such example may be a head-mounted display (HMD) device, such as a wearable eyewear, a wearable headset, or eyeglasses. Head-mounted display devices (HMDs) require smaller size, weight, and limited power consuming components. Thus, there may be a trade-off between capabilities of various display and detection components used in a head-mounted display (HMD) device and their physical characteristics.

Wearable devices, such as a wearable eyewear, wearable headsets, head-mountable devices, and smartglasses, have gained in popularity as forms of wearable systems. In some examples, such as when the wearable devices are eyeglasses or smartglasses, the wearable devices may include transparent or tinted lenses. In some examples, the wearable devices may employ imaging components to capture image content, such as photographs and videos. In some examples, such as when the wearable devices are head-mountable devices or smartglasses, the wearable devices may employ a first projector and a second projector to direct light associated with a first image and a second image, respectively, through one or more intermediary optical components at each respective lens, to generate “binocular” vision for viewing by a user.

Electrically conductive stretchable materials that are movable between neutral, stretched, and/or compressed positions have been an emerging trend in the development of electronics. For instance, electrically conductive stretchable materials have been proposed for use in various types of objects to be used with sensors, detectors of human motion, wearable health monitoring devices, and/or the like. The conductivity through these objects is normally static in that, regardless of the level at which the objects are stretched, electrical conductivity through the objects remains the same or varies minimally.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of a holographic display system, according to an example.

FIG. 2 illustrates a diagram of a flexible optimization-based framework for generating simultaneous color holograms, according to an example.

FIG. 3 illustrates diagrams of the effect of SLM phase range on depth replicas, according to an example.

FIG. 4 illustrates a hologram quality improvement by optimizing with a perceptual loss function, according to an example.

FIG. 5 illustrates a flow diagram of a method for causing a SLM based holographic display to simultaneously display three human-visible wavelengths of light while matching a target image, according to an example.

FIG. 6A illustrates a perspective view of a near-eye display in form of a pair of augmented reality (AR) glasses, according to an example.

FIG. 6B illustrates a top view of a near-eye display in form of a pair of augmented reality (AR) glasses, according to an example.

FIG. 7 illustrates a side cross-sectional view of various optical assembly configurations, according to an example.

FIG. 8 illustrates a side cross-sectional view of an optical lens assembly with one optical element having a flat surface to integrate an electro-optical subsystem layer, according to an example.

FIG. 9 illustrates monochromatic modulation transfer function (MTF) of an optical lens assembly without and with a diffractive optical element (DOE) layer, according to an example.

FIG. 10 illustrates chromatic aberrations of an optical lens assembly without and with a diffractive optical element (DOE) layer, according to an example.

FIG. 11 illustrates polychromatic modulation transfer function (MTF) of an optical lens assembly without and with a diffractive optical element (DOE) layer, according to an example.

FIG. 12A illustrates a phase profile of the diffractive optical element (DOE) layer, according to an example.

FIG. 12B illustrates phase zones for the diffractive optical element (DOE) layer, according to an example.

FIG. 13 illustrates diffractive doublet efficiency and emission spectra for the diffractive optical element (DOE) layer, according to an example.

FIG. 14 illustrates an optical lens assembly with four aspheric surfaces and a diffractive optical element (DOE) layer applied to one of the surfaces, according to an example.

FIG. 15 illustrates another optical lens assembly with three aspheric surfaces and one flat surface and a diffractive optical element (DOE) layer applied to the flat surface, according to an example.

FIG. 16 illustrates chromatic aberrations and polychromatic modulation transfer function (MTF) of the optical lens assembly of FIG. 14, according to an example.

FIG. 17 illustrates chromatic aberrations and polychromatic modulation transfer function (MTF) of the optical lens assembly of FIG. 15, according to an example.

FIG. 18A illustrates a phase profile comparison of the optical lens assemblies of FIGS. 14 and 15, according to an example.

FIG. 18B illustrates a phase zone size comparison of the optical lens assemblies of FIGS. 14 and 15, according to an example.

FIG. 19 illustrates a flow diagram of a method for constructing an optical lens assembly with a diffractive optical element (DOE) layer, according to an example.

FIGS. 20A and 20B depict cross-sectional side views of a conductive polymer composite in certain expansion states, according to an example.

FIG. 21 illustrates a flow diagram of a method for forming a flexible conductive polymer composite, according to an example.

FIGS. 22A and 22B depict top views of a head mounted device including a flexible conductive polymer composite, according to an example.

FIG. 23 illustrates a block diagram of an environment including a wearable device having an imaging component, according to an example.

FIG. 24 illustrates a block diagram of the wearable device depicted in FIG. 1, according to an example.

FIG. 25 illustrates a block diagram of a wearable device and a certain computing apparatus, which may be a computing apparatus to which the wearable device may be paired, according to an example.

FIG. 26 illustrates a perspective view of a wearable device, such as a near-eye display device, and particularly, a head-mountable display (HMD) device, according to an example.

FIG. 27 illustrates a perspective view of a wearable device, such as a near-eye display, in the form of a pair of smartglasses, glasses, or other similar eyewear, according to an example.

FIG. 28 illustrates a flow diagram of a method for transmitting a code to be used to identify geolocation information of a media to an unspecified computing apparatus, according to an example.

FIG. 29 illustrates a map including media arranged in the map according to the locations at which the media were captured, according to an example.

FIG. 30 illustrates a block diagram of a computer-readable medium that has stored thereon computer-readable instructions for transmitting a code and a forwarding request via a short-range wireless communication signal to an unspecified computing apparatus to enable a media to be geotagged, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Computer generated holography (CGH) has long been touted as the future of virtual reality (VR) and augmented reality (AR) displays, but has yet to be realized in practice. Previous high-quality, color holography displays have either made a 3× sacrifice on frame rate by using a sequential illumination scheme or have made use of multiple spatial light modulators (SLM) and/or bulky, complex optical setups. The reduced frame rate of sequential color introduces distracting judder and color fringing in VR and AR while the form factor and cost of current simultaneous color systems are incompatible with the form factor required for VR and AR.

Holographic displays are a promising technology for augmented and virtual reality (AR/VR). Such displays often use a spatial light modulator (SLM) to shape an incoming coherent wavefront so that it appears as though the wavefront came from a real, three-dimensional (3D) object. The resulting image can have natural defocus cues, providing a path to resolve the vergance-accommodation conflict of stereoscopic displays and the fine-grain control offered by holography can also correct for optical aberrations, provide custom eyeglass prescription correction in software, and enable compact form-factors, while improving light efficiency compared traditional LCD or OLED displays. Recent publications have demonstrated significant improvement in hologram image quality and computation time, bringing holographic displays one step closer to practicality. However, color holography for AR/VR has remained an afterthought.

Traditionally, red-green-blue (RGB) holograms are created through field sequential color, where a separate hologram is computed for each of the three wavelengths and displayed in sequence and synchronized with the color of the illumination source. Due to persistence of vision, this appears as a single full color image if the update is sufficiently fast, enabling color holography for static displays. However, in a head-mounted AR/VR system displaying worldlocked content, framerate requirements are higher as slower updates lead to judder. Furthermore, field sequential color may lead to visible spatial separation of the colors, particularly when the user rotates their head while tracking a fixed object with their eyes. Although these negative effects may be mitigated with high framerate displays, the most common SLM technology for holography, liquid-crystal-on-silicon (LCoS), is quite slow due to the physical response time of the liquid crystal (LC) layer. Although most commercial LCoS SLMs may be driven at 60 Hz, at that speed the SLM will likely have residual artifacts from the prior frames. Microelectro-mechanical system (MEMS) SLMs may be much faster in the kilohertz range) but so far have larger pixels and limited bit depth.

Some color holographic displays use field sequential color in which the SLM is sequentially illuminated by red, green, and blue sources while the SLM pattern is updated accordingly. Field sequential color may be effective at producing full color holograms but reduces framerate by a factor of 3×. This a challenge for LCoS SLMs where framerate is severely limited by the LC response time. Although, SLMs based on MEMS technology can run at high framerates in the kilohertz range, so far these modulators are maximum 4-bit display, with most being binary. Even with high framerate modulators, it may be worthwhile to maintain the full temporal bandwidth, since the extra bandwidth may be used to address other holography limitations. For example, speckle may be reduced through temporal averaging, and limited etendue may be mitigated through pupil scanning.

An alternate approach is spatial multiplexing, which maintains the native SLM framerate by using different regions of the SLM for each color. Most prior work in this area often use three separate SLMs and an array of optics to combine the wavefronts. Although this method may produce high quality holograms, the resulting systems tend to be bulky, expensive, and require precise alignment, making them poorly suited for near-eye displays. Spatial multiplexing may also be implemented with a single SLM split into sub-regions; while less expensive, this approach still requires bulky combining optics and sacrifices space-bandwidth product (SBP), also known as etendue. Etendue is already a limiting factor in holographic displays, and further reduction is undesirable as it limits the range of viewing angles or display field-of-view.

Rather than split the physical extent of the SLM into regions, frequency multiplexing assigns each color a different region in the frequency domain, and the colors are separated with a physical color filter at the Fourier plane of a 4f system. A variation on this idea uses different angles of illumination for each color so that the physical filter in Fourier space is not color-specific. Frequency multiplexing may also be implemented with white light illumination, which reduces speckle noise at the cost of resolution. However, all of these techniques involve filtering in Fourier space, which sacrifices system etendue and requires a bulky 4f system.

Another approach that uses simultaneous RGB illumination over the SLM, maintains the full SLM etendue, and doesn't require a bulky 4f system. A first approach may be referred to as depth division multiplexing, which takes advantage of the ambiguity between color and propagation distance and assigns each color a different depth. After optimizing with a single color for the correct multiplane image, undert the first approach, a full color 2D hologram may be formed when illuminating in RGB. However, this first approach does not account for wavelength dependence of the SLM response, and since it explicitly defines content at multiple planes, it translates poorly to 3D.

Another similar approach is bit division multiplexing, which takes advantage of the extended phase range of LCoS SLMs. Under this approach, an SLM lookup-table consisting of phase-values triplets (RGB) as a function of digital SLM input may be calibrated, and that SLMs with extended phase range (up to 10π) may create substantial diversity in the calibrated phase triplets. After pre-optimizing a phase pattern for each color separately, the lookup-table may used on a per-pixel basis to find the digital input that best matches the desired phase for all colors.

Another approach involves applying iterative optimization algorithms to holographic displays. A known approach is the Gerchberg-Saxton (GS) method, which may be effective and easy to implement, but does not have an explicitly defined loss function, making it challenging to adapt to specific applications. This framework has been effective, enabling custom loss functions and flexible adaptation to new optical configurations. In particular, perceptual loss functions can improve the perceived image by taking aspects of human vision into account, such as human visual acuity, foveated vision, and sensitivity to spatial frequencies during accommodation.

A further approach involves camera-calibration of holographic displays. When the model used for hologram generation does not match the physical system, deviations may cause artifacts in the experimental holograms. This issue may be addressed using measurements from a camera in the system for calibration. For instance, feedback from the camera may be used to update the SLM pattern for a particular image This may work for a single image, but does not generalize. A more general approach uses pairs of SLM patterns and camera captures to estimate the learnable parameters in a model, which is then used for offline hologram generation. Learnable parameters may be physically-based, black box CNNs, or a combination of both. The choice of learnable parameters may effect the ability of the model to match the physical system.

Disclosed herein is a framework for simultaneous color holography that allows the use of the full SLM frame rate while maintaining a compact and simple optical setup. According to examples, a single SLM pattern may be used to display RGB holograms, which enables a 3× increase in framerate compared to sequential color and removing color fringing artifacts in the presence of head motion. The features disclosed herein may not use a physical filter in the Fourier plane or bulky optics to combine color channels. Instead, the full SLM is simultaneously illuminated by an on-axis RGB source and the SLM pattern may be optimized to form the three color image. In addition, the features disclosed herein include a design of a flexible framework for end-to-end optimization of the digital SLM input from the target RGB intensity, allowing for SLMs with extended phase range to be optimized. Additionally, and we develop a color-specific perceptual loss function which further improves color fidelity may be available through implementation of the features of the present disclosure.

In the present disclosure, an optimization problem to directly optimize the output hologram may be formulated instead of using a two-step process using an extended SLM phase range. This flexible framework may enable a perceptual loss function to be incorporated to further improve perceived image quality. The present disclosure may use an optimization-based framework, which is adapted to account for the wavelength-dependence of the SLM, which may also enables the perceptual loss function for color, which is based on visual acuity difference between chrominance and luminance channels. In addition, the present disclosure introduces a new parameter for modeling SLM cross talk and tailor the CNN architecture for higher diffraction orders from the SLM.

Through implementation of the features of the present disclosure, simultaneous color holograms that take advantage of extended phase range of an SLM in an end-to-end manner and uses a new loss function based on human color perception may be achieved. As disclosed herein, We the “depth replicas” artifact in simultaneous color holography may be analyzed and how these replicas may be mitigated with extended phase range may be demonstrated through implementation of the features of the present disclosure.

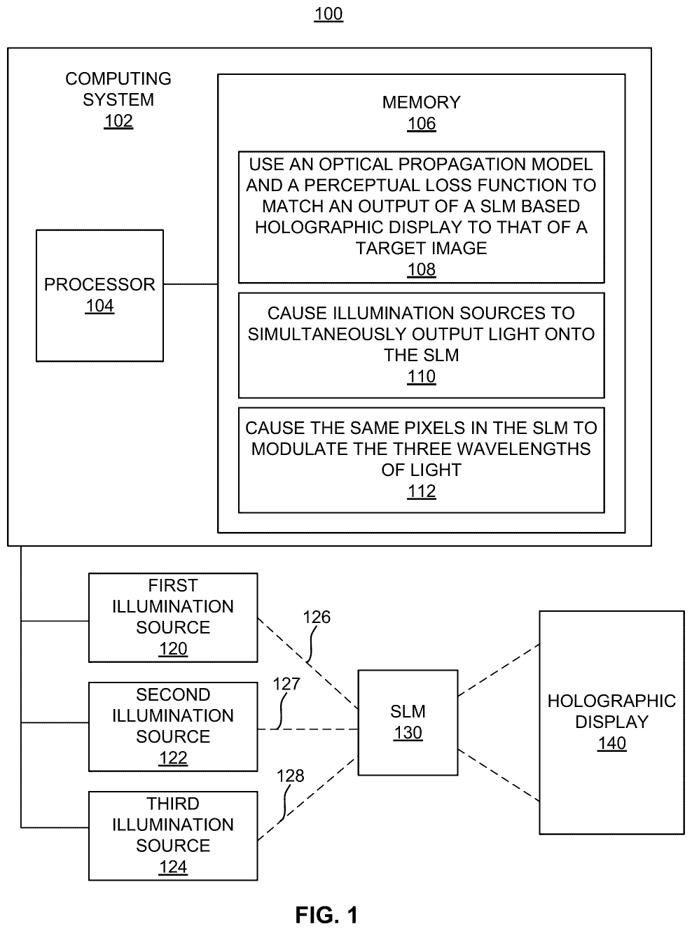

Reference is made to FIG. 1. FIG. 1 illustrates a block diagram of a holographic display system 100, according to an example. The holographic display system 100 is depicted as including a computing system 100, a first illumination source 120, a second illumination source 122, a third illumination source 124, a SLM 130, and a holographic display 140.

The computing system 100 may be a laptop computer, a special purpose computer, a desktop computer, or the like. The computing system 102 may include a processor 104 that may control operations of various components of the computing system 100. The processor 104 may be a semiconductor-based microprocessor, a central processing unit (CPU), an application-specific integrated circuit (ASIC), a field-programmable gate array (FPGA), and/or other hardware device. The processor 104 may be programmed with software and/or firmware that the processor 104 may execute to control operations of the components of the computing system 100.

The computing system 102 may also include a memory 106, which may also be termed a computer-readable medium 106. The memory 106 may be an electronic, magnetic, optical, or other physical storage device that contains or stores executable instructions. The memory 106 may be, for example, Random Access memory (RAM), an Electrically Erasable Programmable Read-Only Memory (EEPROM), a storage device, or an optical disc. For instance, the memory 106 may have stored thereon instructions 108 that cause the processor 104 to use an optical propagation model and perceptual loss function to match an output of a based holographic display 140 to that of a target image, in which an input illumination into the SLM 130 includes three simultaneous human-visible wavelengths of light 126, 127, 128. The optical propagation model and the perceptual loss function are described herein.

The instructions 110 may cause the processor 104 to cause the illumination sources 120-124 to simultaneously output light 126-128 onto the SLM 130. Particularly, for instance, the processor 104 may cause the first illumination source 120 to output light at a first human-visible wavelength 126, e.g., a red color light. The processor 104 may cause the second illumination source 122 to output light at a second human-visible wavelength 127, e.g., a green color light. In addition, the processor 104 may cause the third illumination source 124 to output light at a third human-visible wavelength 128, e.g., a blue color light. The light may be directed to the SLM 130 as shown.

The instructions 112 may cause the processor 104 to cause the SLM 130 to modulate the three human-visible wavelengths of light 126-128 received from the first illumination source 120, the second illumination source 122, and the third illumination source 124 to be modulated by a same set of pixels in the SLM 130. The pixels in the SLM 130 may perturb the three human-visible wavelengths of light 126-128 in different manners according to their respective wavelengths.

According to examples, a holographic image may be created by a coherent (or partially coherent) illumination source incident on the SLM 130. The SLM 130 may imparts a phase delay on the electric field and after light propagates some distance, the intensity of the electric field forms an image, for instance, on the holographic display 140. As discussed herein, a single SLM pattern that simultaneously creates a three color RGB hologram may be computed. For instance, when the SLM 130 is illuminated with a red illumination source, the SLM 130 forms a hologram of the red channel of an image; with a green illumination source, the same SLM pattern forms the green channel; and with the blue illumination source, the SLM 130 creates the blue channel.

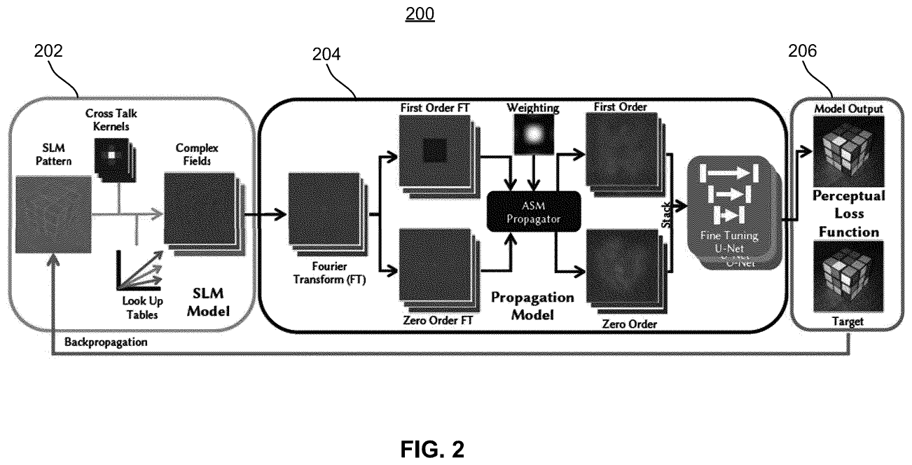

FIG. 2 illustrates a diagram 200 of a flexible optimization-based framework for generating simultaneous color holograms, according to an example. FIG. 2 illustrates the three components of a simultaneous color optimization framework: an SLM model 202, a propagation model 204, and a perceptual loss function 206. The SLM model 202 may map voltage values to a complex field using a learned cross-talk kernel and a linear lookup table. The complex wavefront from the SLM 130 may then be propagated to the sensor plane using a modified version of the model that separates the zeroth and first diffraction orders and combines them through a U-Net. The output is then fed into the perceptual loss function 206, and gradients may be calculated. The SLM voltages may then be updated using these gradients.

Particularly, the framework may start with a generic model for estimating the hologram from the digital SLM pattern, s, as a function of illumination wavelength, A:

$${g}_{λ} = {e}^{i ϕ λ ( s )} \qquad Equation ( 1 )$$

$${I}_{z , λ} = {\vert {f}_{prop} ( {g}_{λ} , z , λ ) \vert}^{2} . \qquad Equation ( 2 )$$

In Equations (1) and (2), ϕλ is a wavelength-dependent function that converts the 8 bit digital SLM pattern to a phase delay, gλ is the electric field coming off the SLM, fprop represents propagation of the electric field, and Iz,λ is the intensity a distance z from the SLM.

To calculate the SLM pattern, s, the following optimization problem may be solved:

$${arg min}_{s} {\sum }_{z} ℒ ( {\hat{I}}_{z , {λ}_{r}} , {I}_{z , {λ}_{r}} ) + ℒ ( {\hat{I}}_{z , {λ}_{g}} , {I}_{z , {λ}_{g}} ) + ℒ ( {\hat{I}}_{z , {λ}_{b}} , {I}_{z , {λ}_{b}} ) , \qquad Equation ( 3 )$$

where \hat{ }I is the target image, L is a pixel-wise loss function such as mean-square error, and λr, λg, λb are the wavelengths corresponding to red, green, and blue respectively. Since the model is differentiable, Equation (3) may be solved with gradient descent.

A common model for propagating electric fields is Fresnel propagation, which may be written in Fourier space as

$${f}_{fresnal} ( g , z , λ ) = {ℱ}^{- 1} \{ ℱ \{ g \} \cdot H ( z , λ ) \} \qquad Equation ( 4 )$$

$$H ( z , λ ) = exp ( i π λ z ( {f}_{x}^{2} + {f}_{y}^{2} ) ) , \qquad Equation ( 5 )$$

where F is a 2D Fourier transform, H is the Fresnel propagation kernel, and fx, fy are the spatial frequency coordinates. In Equation (5), note that λ and z appear together, creating an ambiguity between wavelength and propagation distance.

To see how this ambiguity affects color holograms, consider the case where ϕλ in Equation (1) is independent of wavelength (ϕλ=ϕ). For example, this would be the case if the SLM linearly transformed digital inputs from 0 to 255 to the phase range 0 to 2π at every wavelength. Although this is unrealistic for most off-the-shelf SLMs, this is a useful thought experiment. Note that if ϕ is wavelength-independent, then so is the electric field off the SLM (gλ=g). In this scenario, assuming fprop=ffrensel, the Frensel kernel is the only part of the model affected by wavelength.

Now assume that the SLM forms an image at distance z₀ under red illumination. From the ambiguity in the Frensel kernel, we have the following equivalence:

$$H ( {z}_{0} , {λ}_{r} ) = H ( \frac{{λ}_{g}}{{λ}_{r}} {z}_{0} , {λ}_{g} ) = H ( \frac{{λ}_{b}}{{λ}_{r}} {z}_{0} , {λ}_{b} ) \qquad Equation ( 6 )$$

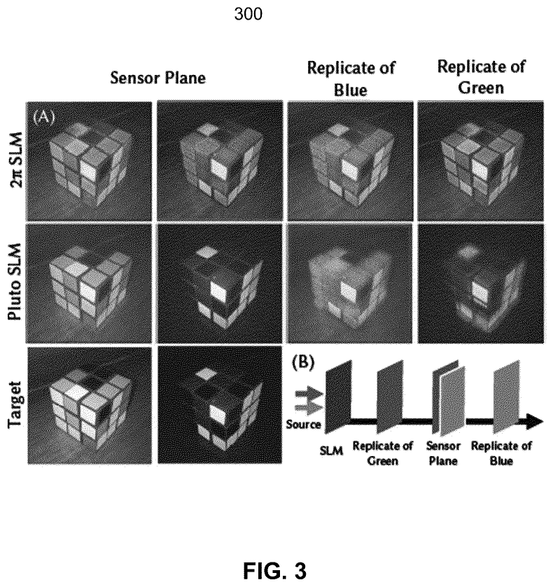

This means the same image formed in red at z₀ will also appear at z=z₀λ_{g}/λᵣ when the SLM is illuminated with green and at z=z₀λ_{b}/λᵣ when the SLM is illuminated with blue. These additional copies may be referred to as “depth replicas.” These phenomena is depicted in FIG. 3, which illustrates diagrams 300 of the effect of SLM phase range on depth replicas, according to an example. The diagrams 300 show that extended phase range reduces depth replicas in simulation. Part (A) of the diagrams 300 illustrates the effect of SLM phase range on depth replicas. All of the holograms shown in the diagrams 300 were calculated using the RGB images and three color channels, but only the green and blue channels are shown for simplicity.

As shown in FIG. 3, holograms simulated using an SLM with a uniform 2π phase range across all color channels may produce strong depth replicas (Row 1) that negatively impact the quality of the sensor plane holograms when compared to the target images (Row 3). However, in row two, these replicas are significantly reduced in holograms simulated with the extended phase Holoeye Pluto-2.1-Vis-016 SLM (Red: 2.4π, Green: 5.9π, Blue: 7.4π). This may improve the quality of the sensor plane holograms in the extended phase case. The locations of the replicate planes and sensor plane are depicted in Part (B) of the diagram 300.

Note that depth replicas do not appear in sequential color holography since the SLM pattern optimized for red is never illuminated with the other wavelengths. If we only care about the hologram at the target plane z₀, then the depth replicas are not an issue, and in fact, we can take advantage of the situation for hologram generation: The SLM pattern for an RGB hologram at z₀ may be equivalent to the pattern that generates a three-plane red hologram where the RGB channels of the target are each at a different depth (z₀, z₀λᵣ/λ_{g}, and z₀λᵣ/λ_{b} for RGB respectively).

Although the approach in which the three-plane hologram is optimized and then RGB is illuminated makes the assumption that ϕ does not depend on λ, this connection between simultaneous color and multi-plane holography suggests simultaneous color should be possible for a single plane, since multiplane holography has been successfully demonstrated in prior work.

However, the ultimate goal of holography is to create 3D imagery, and the depth replicas could prevent placement of arbitrary content over the 3D volume. In addition, in-focus images may appear at depths that should be out-of-focus, which may prevent the hologram from successfully driving accommodation. According to examples, the present disclosure takes advantage of SLMs with extended phase range to mitigate the effects of depth replicas.

In general, the phase OA of the light depends on its wavelength. Perhaps the most popular SLM technology today is LCoS, in which rotation of birefringent LC causes a change in refractive index. The phase of light traveling through the LC layer is delayed by:

$${ϕ}_{λ} = \frac{2 π d}{λ} n ( s , λ ) , \qquad Equation ( 7 )$$

where d is the thickness of the LC layer and n is its refractive index, is controlled with the digital input s. n also depends on A due to dispersion, which is particularly prominent in LC at blue wavelengths.

The wavelength dependence of ϕ_{λ} presents an opportunity to reduce or remove the depth replicas. Even if the propagation kernel H is the same for several (λ, z) pairs, if the phase, and therefore the electric field off the SLM, changes with λ, then the output image intensity at the replica plane will also be different. As the wavelength-dependence of ϕ_{λ} increases, the depth replicas are diminished.

The degree of dependence on λ may be quantified by looking at the derivative dϕ/dλ, which informs us that larger n will give λ more influence on the SLM phase. However, the final image intensity depends only on relative phase, not absolute phase; therefore, for the output image to have a stronger dependence on λ, a larger λn=nₘₐₓ−nₘᵢₙ may be desired. This means larger phase range on the SLM can reduce depth replicas in simultaneous color.

However, there is a trade-off: as the range of phase increases, the limitations of the bit depth of the SLM become more noticeable, leading to increased quantization errors. The effect of quantization on hologram quality may be simulated to find that PSNR and SSIM are almost constant for 6 bits and above. This suggests that each 2π range should have at least 6 bits of granularity. Therefore, use of a phase range of around 8π for an 8-bit SLM may be the best balance between getting rid of depth replicas and maintaining sufficient accuracy for hologram generation. FIG. 3 simulates the effect of extended phase range on depth replica removal. While holograms were calculated on full color images, only two color channels are shown for simplicity.

In the first row of FIG. 3 an SLM is simulated with no wavelength dependence to ϕ (i.e., 0-2π phase range for each color). Consequently, near perfect copies appear at the replica planes. In the second row of FIG. 3, the specifications from an extended phase range SLM (Holoeye Pluto-2.1-Vis-016) is simulated, which has 2.4π range in red, 5.9π range in green, and 7.4π range in blue demonstrating that replicas are substantially diminished with an extended phase range. By reducing the depth replicas, the amount of high frequency out of focus light at the sensor plane is reduced leading to improved hologram quality.

Creating an RGB hologram with a single SLM pattern may be an overdetermined problem as there are 3× more output pixels than degrees of freedom on the SLM. As a result, it may not be possible to exactly match the full RGB image, which may result in color deviations and de-saturation. To address this, the present disclosure may take advantage of color perception in human vision: There is evidence that the human visual systems convert RGB images into a luminance channel (a grayscale image) and two chrominance channels, which contain information about the color. The visual system is only sensitive to high resolution features in the luminance channel, so the chrominance channels may be lower resolution with minimal impact on the perceived image. This observation is used in JPEG compression and subpixel rendering, but may not previously have been applied to holographic displays. By allowing the unperceived high frequency chrominance and extremely high frequency luminance features to be unconstrained, the degrees of freedom on the SLM may better be used to faithfully represent the rest of the image.

The flexible optimization framework as disclosed herein may allow the RGB loss function in Equation (3) to easily be changed to a perceptual loss. For each depth, the RGB intensities of both \hat{ }I (the target image) and I (the simulated image from the SLM) may be transformed into opponent color space as follows:

$${O}_{1} = 0.299 \cdot {I}_{{λ}_{r}} + 0.587 \cdot {I}_{{λ}_{g}} + 0.114 \cdot {I}_{{λ}_{b}} \qquad Equation ( 8 )$$

$${O}_{2} = {I}_{{λ}_{r}} - {I}_{{λ}_{g}}$$

$${O}_{3} = {I}_{{λ}_{b}} - {I}_{{λ}_{r}} - {I}_{{λ}_{g}}$$

where O₁ is the luminance channel, and O₂, O₃ are the red-green and blue-yellow chrominance channels, respectively. Equation (3) may then be updated to:

$${arg min}_{s} {\sum }_{z} [ \text{} ℒ ( {\hat{O}}_{1} * {k}_{1} , {O}_{1} * {k}_{1} ) + ℒ ( {\hat{O}}_{2} * {k}_{2} , {O}_{2} * {k}_{2} ) + ℒ ( {\hat{O}}_{3} * {k}_{3} , {O}_{3} * {k}_{3} ) ] , \qquad Equation ( 9 )$$

where * represents a 2D convolution with a low pass filter (k₁ . . . k₃) for each channel in opponent color space. ôᵢ and Oᵢ are the i-th channel in opponent color space of Î and I, respectively.
implement the Filters in the Fourier domain may be implemented, which may apply a low pass filter 45% of the width Fourier space to the chrominance channels, O₂ and O₃, and a filter 75% of the width of Fourier space to the luminance channel, O₁, to mimic the contrast sensitivity functions of the human visual system.

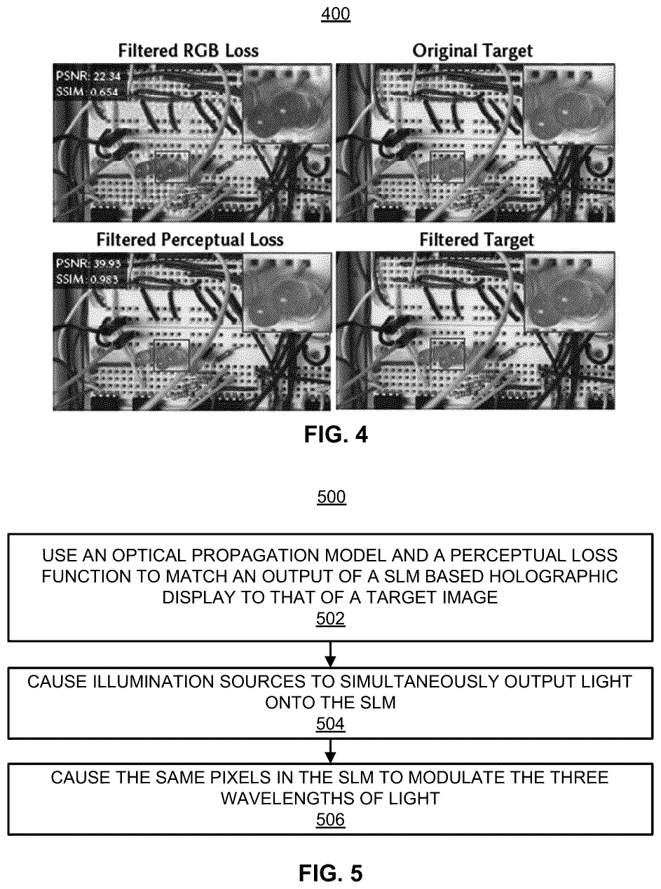

By de-prioritizing high frequencies in chrominance and extremely high frequencies in luminance, the optimizer is able to better match the low frequency color. This low frequency color is what is perceivable by the human visual system. FIG. 4 illustrates the hologram quality improvement by optimizing with a perceptual loss function, according to an example. We see an average PSNR increase of 6.4 dB and average increase of 0.266 in SSIM across a test set of 294 images.

The first column of FIG. 4 contains the perceptually filtered versions of simulated holograms generated using an RGB loss function (Row 1) and our perceptual loss function (Row 2). The second column contains the original target image as well as the perceptually filtered target image. One should note that the two targets are indistinguishable suggesting that our perceptual filter choices fit the human visual system well. The PSNR and SSIM are higher for the perceptually optimized hologram. Additionally, the perceptually optimized hologram appears visually less noisy and with better color fidelity suggesting that the loss function has shifted the majority of the error into imperceptible regions of the opponent color space.

FIG. 4 shows that perceptual loss improves color fidelity and reduces noise in simulation. The first column of this figure depicts simulated holograms that were optimized with an RGB loss function (Row 1) and our perceptual loss function (Row 2). The same filters for the perceptual loss function then were applied to both of these simulated holograms as well as the target image. Image metrics were calculated between the filtered holograms and the filtered target image. All image metrics are better for the perceptually optimized hologram. One should also note that the filtered target and original target are indistinguishable suggesting our perceptual loss function only removes information imperceptible by the human visual system as intended.

The present disclosure may generate simultaneous color holograms in simulation. However, experimental holograms frequently do not match the quality of simulations due to mismatch between the physical system and the model used in optimization (Equations 1, 2). Therefore, to demonstrate simultaneous color experimentally, the model may be calibrated to the experimental system. To do this, a model based on our understanding of the system's physics may be designed, but we include several learnable parameters representing unknown elements. To fit the parameters, a dataset of SLM patterns and experimental and use gradient descent may be captured to estimate the learnable parameters based on the dataset. A summary of the model is presented in FIG. 2 and summarized below.

An element in the optimization disclosed herein is OA, which converts the digital SLM input into the phase coming off the SLM, and it may be important that this function accurately matches the behavior of the real SLM. Many commercial SLMs ship with a lookup-table (LUT) describing OA. However, since the function depends on wavelength as described in Equation (7) and the manufacturer LUT is generally calibrated at a few discrete wavelengths, it may not be accurate for the source used in the experiment. Therefore, we may learn a LUT for each color channel as part of the model. Based on a pre-calibration of the LUT, the LUT may be observed as being close to linear; the LUT may thus be parameterized with a linear model to encourage physically realistic solutions.

SLMs are usually modeled as having a constant phase over each pixel with sharp transitions at boundaries. However, in LCoS SLMs, elastic forces in the LC layer may prevent sudden spatial variations, and the electric field that drives the pixels changes gradually over space. As a result, LCoS SLMs may suffer from crosstalk, also called field-fringing, in which the phase is blurred. The cross talk may be modeled with a convolution on the SLM phase. Combined with a linear LUT described above, the phase off the SLM may be described as:

$${ϕ}_{λ} ( s ) = {k}_{xt} * ( {a}_{1} \cdot s + {a}_{2} ) \qquad Equation ( 10 )$$

where α₁, α₂ are the learned parameters of the LUT, and kₓₜ is a learned 5×5 convolution kernel representing crosstalk. Separate values of these parameters are learned for each color channel.

The discrete pixel structure on the SLM creates higher diffraction orders that are not modeled well with ASM or Fresnel propagation. A physical aperture at the Fourier plane of the SLM may be used to block higher orders. However, accessing the Fourier plane requires a 4f system, which adds significant size to the optical system, reducing the practicality for head-mounted displays. Therefore, we chose to avoid additional lenses after the SLM and instead account for high orders in the propagation model.

We adapt the higher-order angular spectrum model (HOASM) of Gopakumar et al. The zero order diffraction, G(fx, fy), and first order diffraction, G1st order patterns are propagated with ASM to the plane of interest independently. Then the propagated fields are stacked and passed into a U-net, which combines the zero and first orders and returns the image intensity:

$${f}_{ASM} ( G , z ) = {ℱ}^{- 1} \{ G \cdot {H}_{ASM} ( z ) \} \qquad Equation ( 11 )$$

$${I}_{z} = Unet ( {f}_{ASM} ( G , z ) , {f}_{ASM} ( {G}_{1 st order} , z ) ) , \qquad Equation ( 12 )$$

where H_{ASM}(z) is the ASM kernel. A separate U-net for each color is learned from the data.

The U-Net helps to address any unmodeled aspects of the system that may affect the final hologram quality such as source polarization, SLM curvature, and beam profiles. The U-Net helps correct for these by allowing the model to adapt to changes in the system, as seen when retraining the model after rotating the polarizer resulted in the U-Net parameters changing drastically while the physical parameters remained relatively constant. Additionally, the U-Net may also help account for physics simplifications, such as modeling the SLED as three single wavelength sources. Finally, the U-net better models superposition of orders, allowing for more accurate compensation in SLM pattern optimization.

Various manners in which the processor 104 of the computing system 102 may operate are discussed in greater detail with respect to the method 500 depicted in FIG. 5. FIG. 5 illustrates a flow diagram of a method 500 for causing a SLM based holographic display to simultaneously display three human-visible wavelengths of light while matching a target image, according to an example. It should be understood that the method 500 depicted in FIG. 5 may include additional operations and that some of the operations described therein may be removed and/or modified without departing from the scope of the method 500. The description of the method 500 is made with reference to the features depicted in FIGS. 1-4 for purposes of illustration.

At block 502, the processor 104 may use an optical propagation model and perceptual loss function to match an output of a based holographic display 140 to that of a target image, in which an input illumination into the SLM 130 includes three simultaneous human-visible wavelengths of light 126, 127, 128.

At block 504, the processor 104 may cause the illumination sources 120-124 to simultaneously output light 126-128 onto the SLM 130.

At block 506, the processor 104 may cause the SLM 130 to modulate the three human-visible wavelengths of light 126-128 received from the first illumination source 120, the second illumination source 122, and the third illumination source 124 to be modulated by a same set of pixels in the SLM 130.

Some or all of the operations set forth in the method 500 may be included as a utility, program, or subprogram, in any desired computer accessible medium. In addition, the method 500 may be embodied by a computer program, which may exist in a variety of forms both active and inactive. For example, they may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

As used herein, a “near-eye display” may refer to any display device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein, a “user” may refer to a user or wearer of a “near-eye display.” A “wearable device” may refer to any portable electronic device that may be worn by a user and include a camera and/or a display to capture and/or present content to a user. Examples of “wearable devices” may include, but are not limited to, smart watches, smart phones, headsets, and near-eye display devices.

In some examples of the present disclosure, an optical lens assembly for use within virtual reality (VR) systems such as augmented reality (AR), virtual reality (VR) near-eye display devices is described. At least one surface of the optical lens elements within the optical lens assembly may have a planar surface to eliminate contrast reduction and ghosting that may be associated with an air gap. Electro-optical module layers may be integrated with the planar surface. The planar surface may be the last exterior surface (e.g., L2S2) may be achieved by adding a diffractive optical element (DOE) layer to the planar surface.

While some advantages and benefits of the present disclosure are apparent, other advantages and benefits may include reduction or elimination of undesirable effects such as contrast reduction or ghosting due to a gap between elements of the optical assembly when an electro-optical layer is added. By adding the diffractive optical element (DOE) layer, an overall thickness and weight of the optical assembly may be reduced. Furthermore, additional enhancements may be provided by the diffractive optical element (DOE) layer.

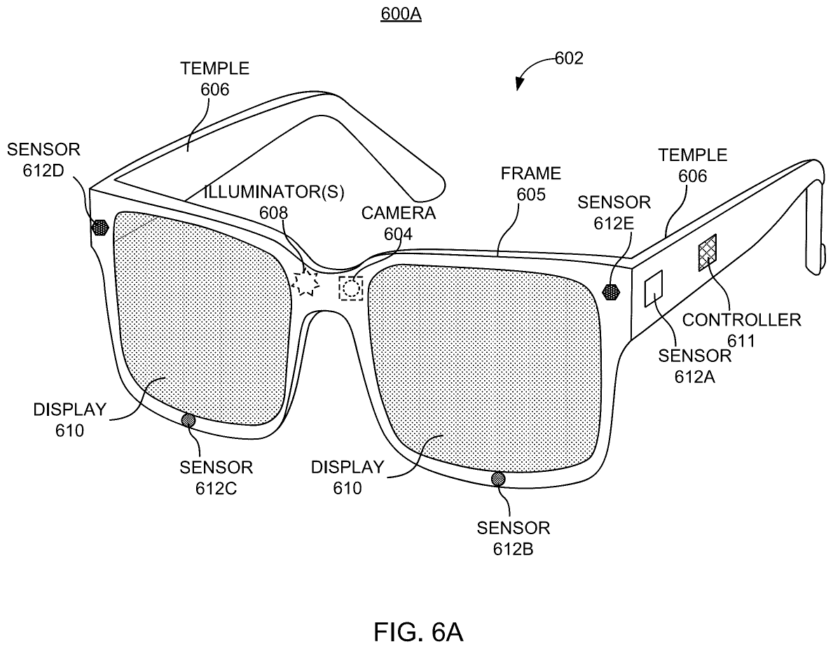

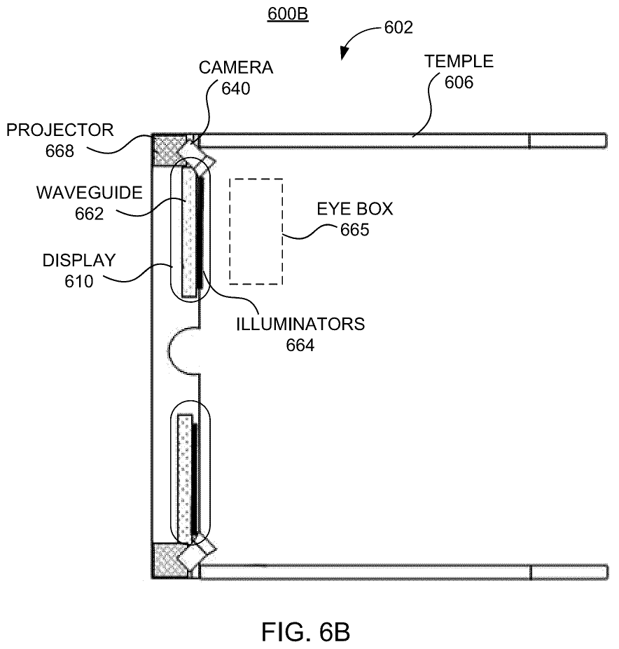

FIG. 6A is a perspective view of a near-eye display 602 in the form of a pair of glasses (or other similar eyewear), according to an example. In some examples, the near-eye display 602 may be configured to operate as a virtual reality display, an augmented reality (AR) display, and/or a mixed reality (MR) display.

As shown in diagram 600A, the near-eye display 602 may include a frame 605 and a display 610. In some examples, the display 610 may be configured to present media or other content to a user. In some examples, the display 610 may include display electronics and/or display optics. For example, the display 610 may include a liquid crystal display (LCD) display panel, a light-emitting diode (LED) display panel, or an optical display panel (e.g., a waveguide display assembly). In some examples, the display 610 may also include any number of optical components, such as waveguides, gratings, lenses, mirrors, etc. In other examples, the display 610 may include a projector, or in place of the display 610 the near-eye display 602 may include a projector. The projector may use laser light to form an image in angular domain on an eye box for direct observation by a viewer's eye, and may include a vertical cavity surface emitting laser (VCSEL) emitting light at an off-normal angle integrated with a photonic integrated circuit (PIC) for high efficiency and reduced power consumption.

In some examples, the near-eye display 602 may further include various sensors 612A, 612B, 612C, 612D, and 612E on or within a frame 605. In some examples, the various sensors 612A-612E may include any number of depth sensors, motion sensors, position sensors, inertial sensors, and/or ambient light sensors, as shown. In some examples, the various sensors 612A-612E may include any number of image sensors configured to generate image data representing different fields of views in one or more different directions. In some examples, the various sensors 612A-612E may be used as input devices to control or influence the displayed content of the near-eye display, and/or to provide an interactive virtual reality (VR), augmented reality (AR), and/or mixed reality (MR) experience to a user of the near-eye display 602. In some examples, the various sensors 612A-612E may also be used for stereoscopic imaging or other similar application.

In some examples, the near-eye display 602 may further include one or more illuminators 608 to project light into a physical environment. The projected light may be associated with different frequency bands (e.g., visible light, infra-red light, ultra-violet light, etc.), and may serve various purposes. In some examples, the one or more illuminator(s) 608 may be used as locators.

In some examples, the near-eye display 602 may also include a camera 604 or other image capture device. The camera 604, for instance, may capture images of the physical environment in the field of view. In some instances, the captured images may be processed, for example, by a virtual reality engine to add virtual objects to the captured images or modify physical objects in the captured images, and the processed images may be displayed to the user by the display 610 for augmented reality (AR) and/or mixed reality (MR) applications.

In some examples, the near-eye display 602 may also include an optical lens assembly to process and focus light from the display (e.g., a waveguide display) onto the eye box. The optical lens assembly may include two or more optical lenses and/or other optical elements such as a phase plate, a polarizer, and so on. At least one surface of the optical lens elements within the optical lens assembly may have a planar surface to eliminate contrast reduction and ghosting that may be associated with an air gap. One or more electro-optical module layers may be integrated with the planar surface. The planar surface may be the last exterior surface (e.g., L2S2) may be achieved by adding a diffractive optical element (DOE) layer to the planar surface.

FIG. 6B is a top view of a near-eye display 602 in the form of a pair of glasses (or other similar eyewear), according to an example. As shown in diagram 600B, the near-eye display 602 may include a frame 605 having a form factor of a pair of eyeglasses. The frame 605 supports, for each eye: a scanning projector 668 such as any scanning projector variant considered herein, a pupil-replicating waveguide 662 optically coupled to the projector 668, an eye-tracking camera 640, and a plurality of illuminators 664. The illuminators 664 may be supported by the pupil-replicating waveguide 662 for illuminating an eye box 665. The projector 668 may provide a fan of light beams carrying an image in angular domain to be projected into a user's eye.

In some examples, multi-emitter laser sources may be used in the projector 668. Each emitter of the multi-emitter laser chip may be configured to emit image light at an emission wavelength of a same color channel. The emission wavelengths of different emitters of the same multi-emitter laser chip may occupy a spectral band having the spectral width of the laser source. The projector 668 may include, for example, two or more multi-emitter laser chips emitting light at wavelengths of a same color channel or different color channels. For augmented reality (AR) applications, the pupil-replicating waveguide 662 may be transparent or translucent to enable the user to view the outside world together with the images projected into each eye and superimposed with the outside world view. The images projected into each eye may include objects disposed with a simulated parallax, so as to appear immersed into the real-world view.

The eye-tracking camera 640 may be used to determine position and/or orientation of both eyes of the user. Once the position and orientation of the user's eyes are known, a gaze convergence distance and direction may be determined. The imagery displayed by the projector 668 may be adjusted dynamically to account for the user's gaze, for a better fidelity of immersion of the user into the displayed augmented reality scenery, and/or to provide specific functions of interaction with the augmented reality. In operation, the illuminators 664 may illuminate the eyes at the corresponding eye boxes 665, to enable the eye-tracking cameras to obtain the images of the eyes, as well as to provide reference reflections. The reflections (also referred to as “glints”) may function as reference points in the captured eye image, facilitating the eye gazing direction determination by determining position of the eye pupil images relative to the glints. To avoid distracting the user with illuminating light, the latter may be made invisible to the user. For example, infrared light may be used to illuminate the eye boxes 166.

Functions described herein may be distributed among components of the near-eye display 602 in a different manner than is described here. Furthermore, a near-eye display as discussed herein may be implemented with additional or fewer components than shown in FIGS. 6A and 6B. While the near-eye display 602 is shown and described in form of glasses, a flat-surfaced, electrically controlled, tunable lens may be implemented in other forms of near-eye displays such as goggles or headsets, as well as in non-wearable devices such as smart watches, smart phones, and similar ones.

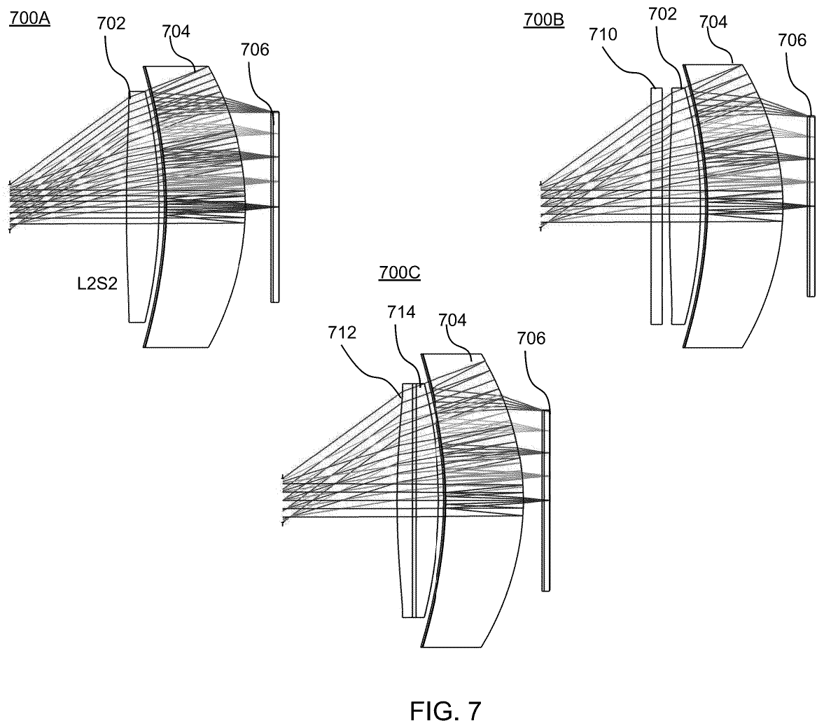

FIG. 7 illustrates a side cross-sectional view of various optical assembly configurations, according to an example. Diagram 700A in FIG. 7 shows an optical lens assembly of a virtual reality display device that includes a first optical lens 702, a second optical lens 704, and a display 706 from which the virtual reality content is provided onto an eye box by the optical lens assembly. Optical elements (lenses) of an optical lens assembly commonly have four aspherical optical surfaces to provide high resolution imagery over a wide field-of-view (FOV) as shown in diagram 700A.

In some examples, one or more electro-optical subsystems such as accommodation, biometrics, 3D sensing, etc. may be included in the virtual reality display device. Electro-Optical subassemblies, including accommodative modules and sensing structures, are fabricated on planar substrates. Thus, integration of electro-optical subsystems with the optical lens assembly may require additional spacing between a last surface (L2S2) of the optical lens assembly (eye box side) and the substrates on which the electro-optical subsystems are formed. The additional spacing may, therefore, increase an overall axial thickness of the virtual reality system as shown in diagram 700B of FIG. 7, which includes display 706, second optical lens 704, first optical lens 702, and electro-optical subsystem layer 710. The spacing between the last surface L2S2 and the planar surface of the electro-optical subsystem layer 710 may also result in reduced image contrast and increased possibility of ghosting associated with reflections between the last surface L2S2 and the planar surface of the electro-optical subsystem layer 710.

In some examples, the planar electro-optical subsystem layer may be integrated with two lens components to avoid the air gap between the last surface L2S2 and the planar interface of the electro-optical subsystem layer, as shown in diagram 7000, where the electro-optical subsystem layer 712 is integrated with optical lens 714. This multi-component assembly may result in significant center thickness (CT) variations of the integrated optical lens assembly, for example, by as much as +/−100 micrometers. The center thickness (CT) changes may result in performance degradation of the visual optics module.

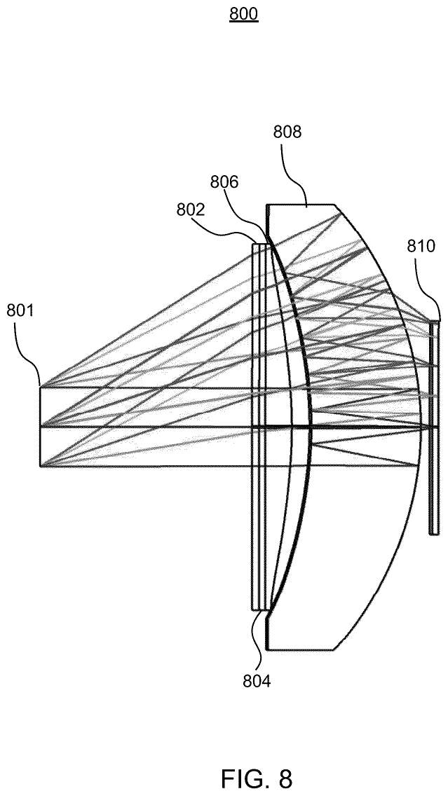

FIG. 8 illustrates a side cross-sectional view of an optical lens assembly with one optical element having a flat surface to integrate an electro-optical subsystem layer, according to an example. Diagram 800 shows light (virtual display content) from a display 810 being processed and focused onto an eye box 801 through an optical lens assembly that includes a first optical lens 806, a second optical lens 808, an electro-optical subsystem layer 802, and a diffractive optical element (DOE) layer 804.

To avoid the disadvantages of the systems discussed above, the optical lens assembly may be designed with a last surface L2S2 being a flat surface, so that the electro-optical subsystem layer 802 may be integrated with the planar interface of L2S2, as shown in the diagram 800. The planar surface integration may provide compact design (for example, improvement in the total axial length of the lens assembly by >10%) and eliminate contrast reduction and ghosting associated with the air gap. However, making the last surface L2S2 as a planar surface leaves the optical lens assembly with only three aspheric surfaces, and reduces a number of degrees of freedom available for aberration correction of the optical lens assembly.

As mentioned herein, the planar interface between the last surface L2S2 and the electro-optical subsystem layer 802 may provide advantages when additional functional integration is necessary, including integration of electro-optical components such as accommodation and eye-tracking components, as well as prescription lenses for myopic and hyperopic correction. Increase in the degrees of freedom for aberration corrections, while keeping the integration surface planar may be achieved by adding a diffractive optical element (DOE) layer 804 with a phase profile to correct for lens monochromatic aberrations, along with the remaining three aspheric surfaces. The diffractive optical element (DOE) layer 804 may also provide correction of lateral chromatic aberrations of the optical lens assembly, further improving the assembly's off-axis imaging performance. In some examples, the diffractive optical element (DOE) layer 804 may be produced based on different technologies, including surface-relief diffractive structures, volume holograms, polarization sensitive geometric phase diffractive structures, meta-surfaces, etc.

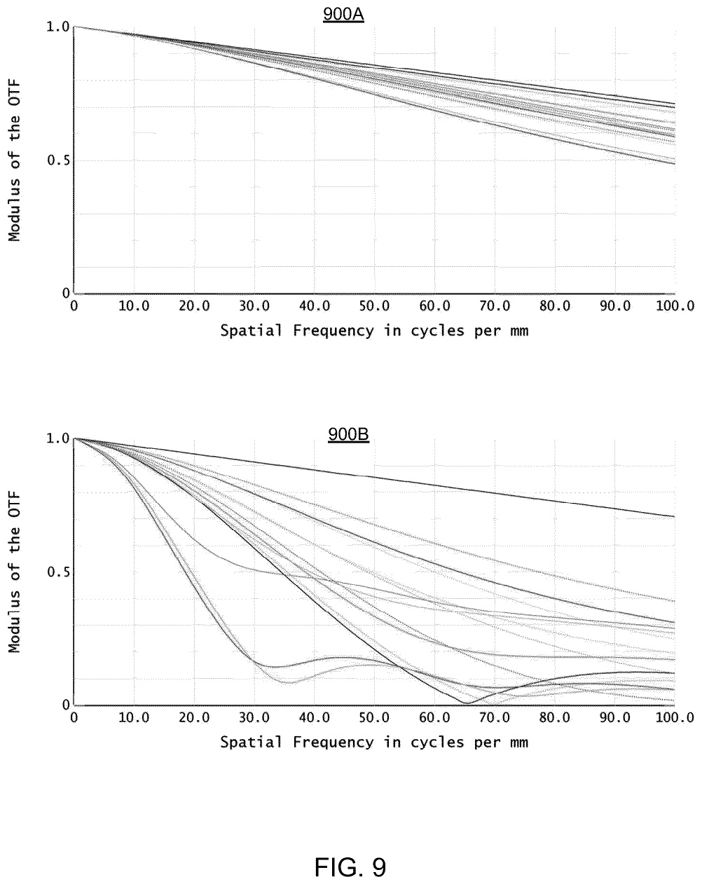

FIG. 9 illustrates monochromatic modulation transfer function (MTF) of an optical lens assembly without and with a diffractive optical element (DOE) layer, according to an example. FIG. 9 includes diagram 900A illustrating the modulation transfer function (MTF) of an optical lens assembly with a diffractive optical element (DOE) layer and diagram 900B illustrating the modulation transfer function (MTF) of an optical lens assembly without a diffractive optical element (DOE) layer.

An optical transfer function (OTF) of an optical system specifies how different spatial frequencies are captured or transmitted. The modulation transfer function (MTF) is similar to the optical transfer function (OTF) but ignores phase effects and may be equivalent to the optical transfer function (OTF) in many situations. Both transfer functions specify a response to a periodic sine-wave pattern passing through the optical system, as a function of its spatial frequency or period, and its orientation. The optical transfer function (OTF) may be defined as the Fourier transform of a point spread function (PSF), an impulse response of the optical system to an image of a point source. The optical transfer function (OTF) has a complex value, whereas the modulation transfer function (MTF) is defined as the magnitude of the complex optical transfer function (OTF).

The modulation transfer function (MTF) curves provide a composite view of how optical aberrations affect performance at a set of fundamental parameters. A top curve (solid black line) represents a diffraction limit of the optical system, which is an absolute limit of lens performance. The additional colored lines on the curves below the diffraction limit represent the actual modulation transfer function (MTF) performance of the optical system. The curves may correspond to different field heights (positions across the sensor). As diagrams 900A and 900B show, the addition of the diffractive optical element (DOE) layer to the optical lens assembly provides a marked enhancement in the overall optical performance of the optical lens assembly.

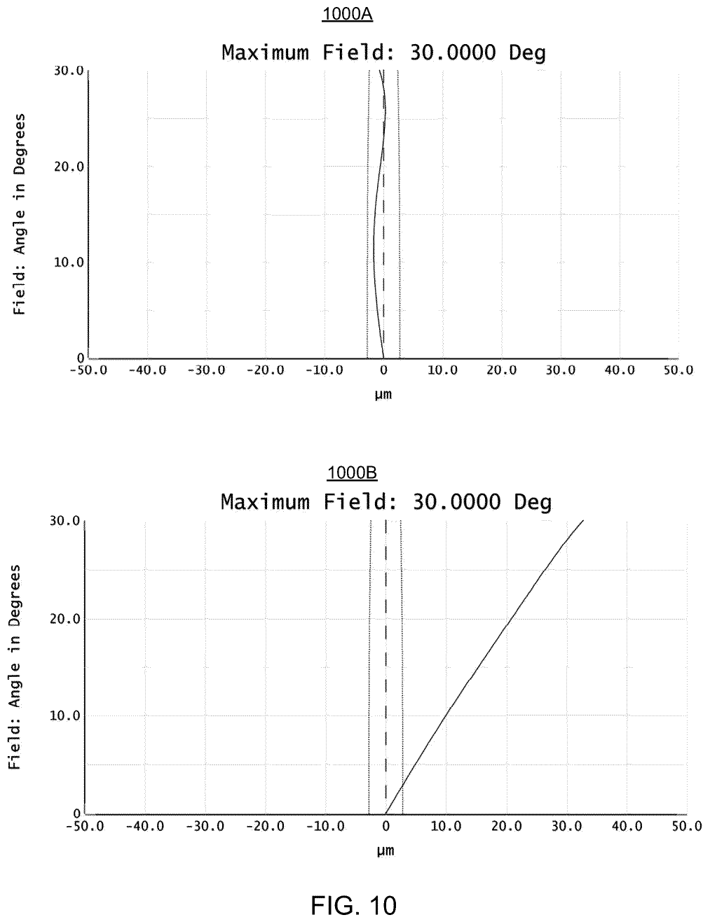

FIG. 10 illustrates chromatic aberrations of an optical lens assembly without and with a diffractive optical element (DOE) layer, according to an example. Diagrams 1000A and 1000B in FIG. 10 show lateral chromatic aberrations for an optical lens assembly for a maximum field of view angle of 30 degrees with a diffractive optical element (DOE) layer (diagram 1000A) and without a diffractive optical element (DOE) layer (diagram 1000A).

As shown in diagram 1000A, the chromatic aberrations for the optical lens assembly with a diffractive optical element (DOE) layer remain within a reasonable band of +/−3 micrometers for varying field of view angle (up to 30 degrees), whereas the chromatic aberrations for the optical lens assembly without a diffractive optical element (DOE) layer diverge dramatically as the field of view angle increases (e.g., up to 30+ micrometers). The difference between the two configurations shows the marked improvement for chromatic aberrations provided by the diffractive optical element (DOE) layer addition to the optical lens assembly.

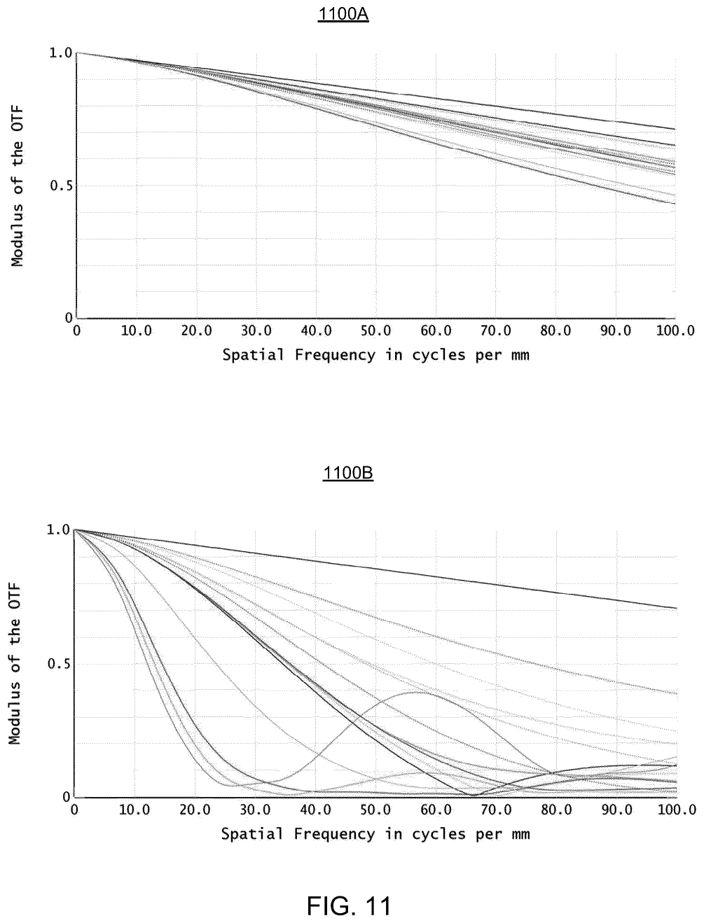

FIG. 11 illustrates polychromatic modulation transfer function (MTF) of an optical lens assembly without and with a diffractive optical element (DOE) layer, according to an example. Contrasted with FIG. 9 showing monochromatic modulation transfer functions (MTFs), FIG. 11 includes diagram 1100A illustrating the polychromatic modulation transfer function (MTF) of an optical lens assembly with a diffractive optical element (DOE) layer and diagram 1100B illustrating the polychromatic modulation transfer function (MTF) of an optical lens assembly without a diffractive optical element (DOE) layer.

As diagrams 1100A and 11001B show, the addition of the diffractive optical element (DOE) layer to the optical lens assembly provides a marked enhancement in the polychromatic optical performance of the optical lens assembly as well.

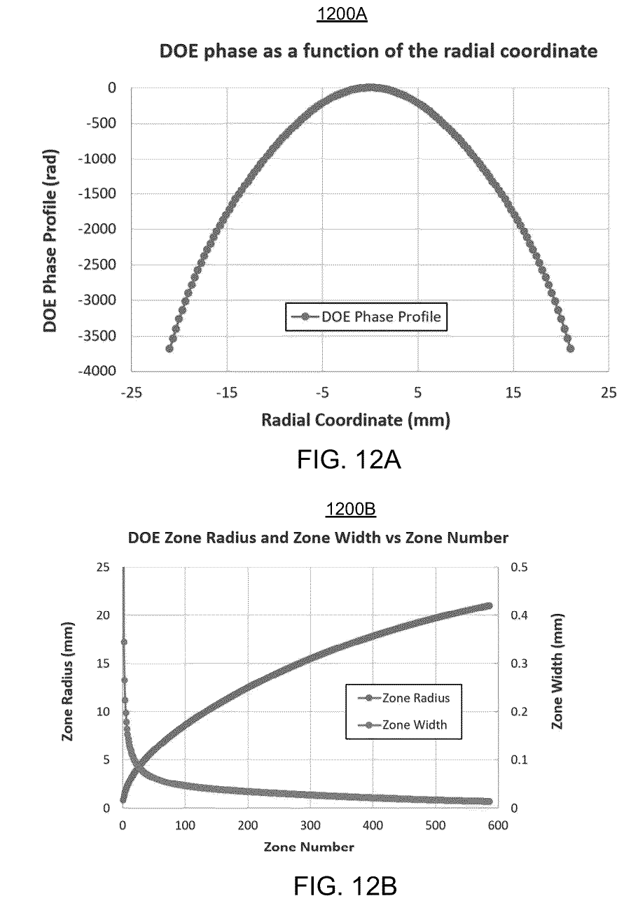

FIG. 12A illustrates a phase profile of the diffractive optical element (DOE) layer, according to an example. Diagram 1200A presents an exemplary phase profile in radians for the diffractive optical element (DOE) layer in an optical lens assembly to correct for chromatic and monochromatic aberrations.

A diffractive optical element (DOE) layer may be formed, in some examples, with a thin structure of rings on its surface with each ring having a different tooth-like profile. Light passing through the rings may be delayed in a proportion to the height along the radius, creating a radial phase profile that is similar to that of a regular lens. This phase profile may then cause the light beam to focus or diverge. As mentioned herein, the diffractive optical element (DOE) layer may be formed using a variety of techniques and a variety of surface shapes and patterns. Thus, the diffractive optical element (DOE) layer phase profile may be selected depending on the desired focus distance, aberration corrections, etc.

FIG. 12B illustrates phase zones for the diffractive optical element (DOE) layer, according to an example. Diagram 1200B shows zone radius and zone width curves changing with a zone number of an example diffractive optical element (DOE) layer.

A diffractive optical element is composed of a series of zones that become finer towards the edge of the element. Thus, the phase profile is usually sub-divided into multiple phase zones, where each zone has the width that is varying as a function of the radial coordinate, as shown in diagram 1200B. When the diffractive optical element (DOE) layer is designed to operate in a first diffraction order, each zone may produce optical path difference (OPD) with respect to the neighboring zones of approximately one (1) wavelength, corresponding to a phase delay between the neighboring zones of approximately 2π over the diffractive optical element (DOE) layer operating spectral range.

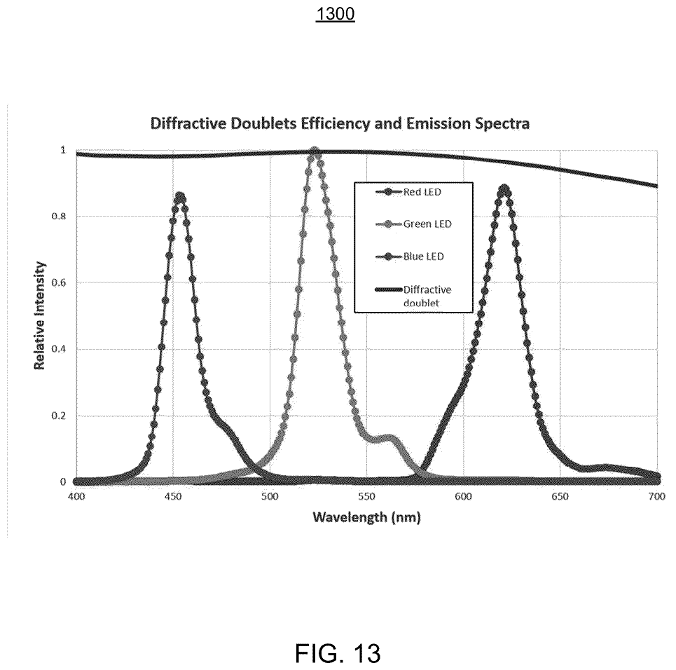

FIG. 13 illustrates diffractive doublet efficiency and emission spectra for the diffractive optical element (DOE) layer, according to an example. Diagram 1300 shows red, blue, and green color bands in comparison with a diffractive doublet emission.

In addition to the overall phase profile of the diffractive optical element (DOE) layer for aberration correction, the diffractive optical element (DOE) layer may also maximize diffraction efficiency over the operating spectral ranges. In virtual reality applications, imagery is produced by pixelated displays that typically have three discrete color bands, red, blue, and green. To increase diffraction efficiency over a broad spectral range, multi-layer surface-relief or liquid crystal polymer diffractive optical element (DOE) layers may be employed. Diagram 1300 shows diffraction efficiency of a dual-layer surface-relief diffractive optical element (DOE) layer optimized for the three discrete color bands produced by the pixelated display.

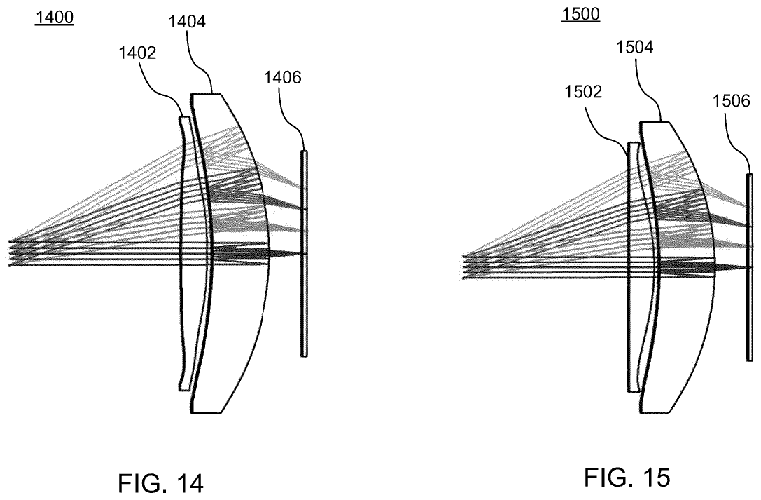

In some examples, a flat surface interface as part of an optical lens assembly second lens surface (referred to as L2S2) has advantages associated with manufacturability and improved performance of the diffractive structures. Diffraction efficiency and sensitivity to fabrication imperfections of diffractive structures depend on the local pitch size of the diffractive phase profile. With the reduction in the pitch size diffraction efficiency in the working diffraction order may be reduced, with more optical power being spread into the spurious diffraction orders, resulting in reduced image contrast. Susceptibility to fabrication defects, such as changes in profile shape and in refractive index, may increase with the reduction in pitch size, further reducing diffraction efficiency in the working diffraction order and reduced image contrast. To establish optical lens assemblies where comparable levels of lateral chromatic aberration correction can be achieved with larger pitch values of the diffractive structures further optical lens assembly configurations may be provided as described in conjunction with FIGS. 14 and 15.

FIG. 14 illustrates an optical lens assembly with four aspheric surfaces and a diffractive optical element (DOE) layer applied to one of the surfaces, according to an example. Diagram 1400 shows an optical lens assembly with a first optical lens 1402, a second optical lens 1404, and display 1406. Both first and second optical lenses 1402 and 1404 have aspheric surfaces with an electro-optical subsystem layer being applied to the aspheric L2S2 surface of the first optical lens 1402.

FIG. 15 illustrates another optical lens assembly with three aspheric surfaces and one flat surface and a diffractive optical element (DOE) layer applied to the flat surface, according to an example. Diagram 1500 shows another optical lens assembly with a first optical lens 1502, a second optical lens 1504, and display 1506. While the second optical lens 1504 has aspheric surfaces, the first optical lens 1502 has a flat L2S2 surface to which an electro-optical subsystem layer may be applied.

In some examples, the aspheric surface profiles of the first and second optical lenses 1502 and 1504 may be selected such that the optical lens assemblies of diagrams 1400 and 1500 produce comparable levels of lateral chromatic aberration correction. In the optical lens assembly of FIG. 14, a diffractive optical element (DOE) layer may be applied to the aspheric L2S2 surface of the first optical lens 1402 and in the optical lens assembly of FIG. 15, the diffractive optical element (DOE) layer may be applied to the planar L2S2 surface of the first optical lens 1502.

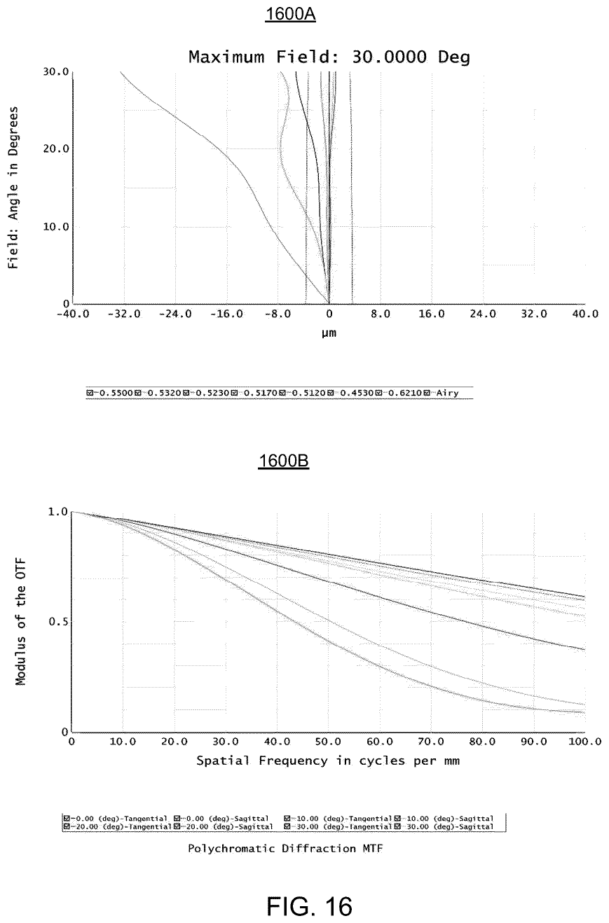

FIG. 16 illustrates chromatic aberrations and polychromatic modulation transfer function (MTF) of the optical lens assembly of FIG. 14, according to an example. Diagram 1100A shows lateral polychromatic aberrations for the optical lens assembly of FIG. 14 with a maximum field of view angle of 30 degrees with a diffractive optical element (DOE) layer applied to the aspheric L2S2 surface of the assembly. Diagram 1600B illustrates the modulation transfer function (MTF) of the optical lens assembly of FIG. 14.

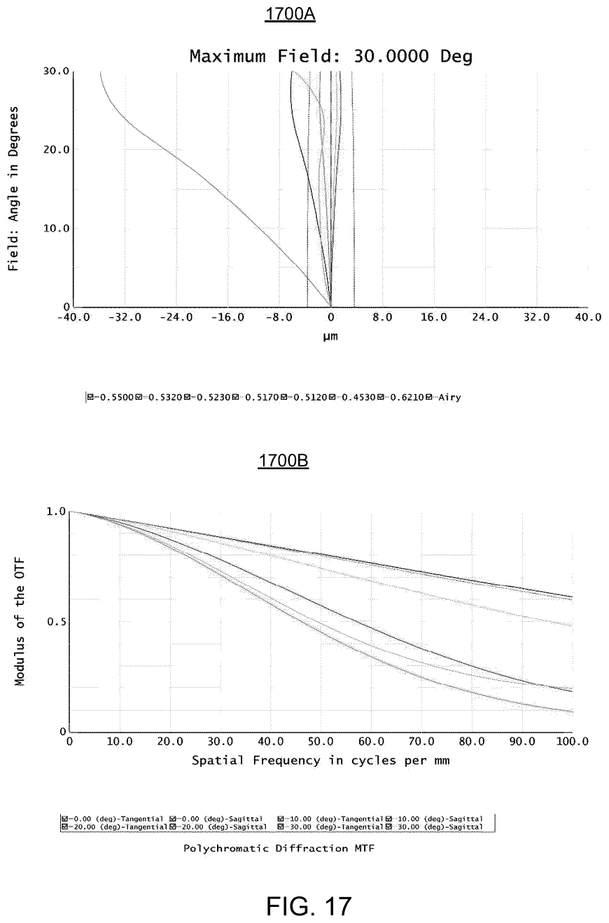

FIG. 17 illustrates chromatic aberrations and polychromatic modulation transfer function (MTF) of the optical lens assembly of FIG. 15, according to an example. Diagram 1700A shows lateral polychromatic aberrations for the optical lens assembly of FIG. 15 with a maximum field of view angle of 30 degrees with a diffractive optical element (DOE) layer applied to the flat L2S2 surface of the assembly. Diagram 1700B illustrates the modulation transfer function (MTF) of the optical lens assembly of FIG. 15.

Diagrams 1600A and 1700A show how the optical lens assemblies of the FIGS. 14 and 15 (with all aspheric and one flat L2S2 surface) produce comparable levels of lateral chromatic aberration correction. As shown in both diagrams, most aberrations remain within a reasonable band of +/−4 micrometers for varying field of view angle (up to 30 degrees) with one aberration diverging. Diagrams 1600B and 1700B also show no marked difference between the polychromatic modulation transfer functions (MTFs) of the optical lens assemblies of FIGS. 14 and 15.

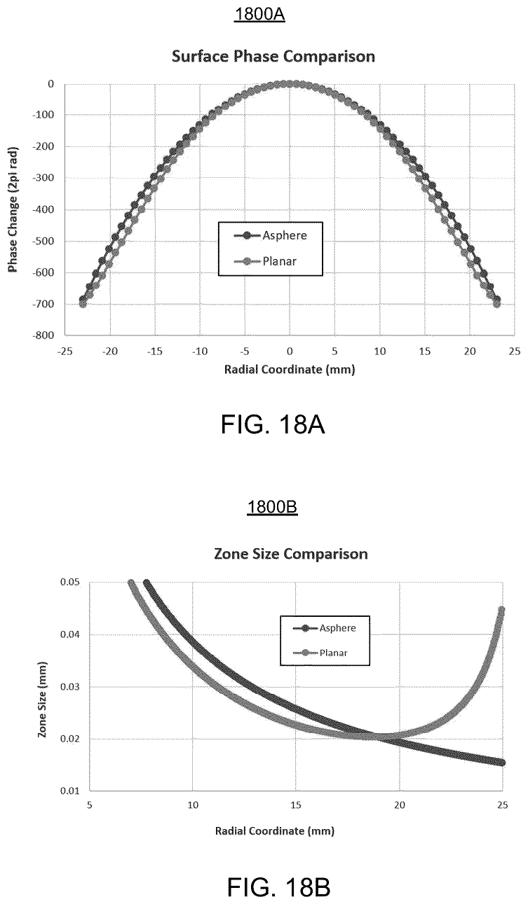

FIG. 18A illustrates a phase profile comparison of the optical lens assemblies of FIGS. 14 and 15, according to an example. Diagram 1800A shows surface phase comparison between the optical lens assemblies of FIGS. 14 and 15.

FIG. 18B illustrates a phase zone size comparison of the optical lens assemblies of FIGS. 14 and 15, according to an example. Diagram 1800B shows zone size comparison between the optical lens assemblies of FIGS. 14 and 15.

Diagram 1800A shows surface phase profiles as a function of the radial coordinate for the diffractive structures associated with the optical lens assemblies of FIGS. 14 and 15. The amount of phase change over the aspheric profile is smaller, resulting in about 686 waves of optical path difference, as compared to the planar surface that produces about 701 waves of optical path difference over the planar surface. The optical path differences are for an example wavelength of 0.520 micrometers in both cases.

Diagram 1800B shows phase zone size comparison as a function of the radial coordinate for the diffractive structures associated with the optical lens assemblies of FIGS. 14 and 15. The total number of the phase zones for the diffractive structures with the surface phase profiles in FIG. 14, calculated for the wavelength of 0.520 micrometers, are 810 and 761 phase zones, respectively. The smallest zone size for the assembly in FIG. 14 with aspheric L2S2 is about 15.5 micrometers, while the smallest zone size for the assembly in FIG. 10 with the planar L2S2 is about 20.4 micrometers, providing above mentioned advantages with respect to diffraction efficiency and manufacturability.

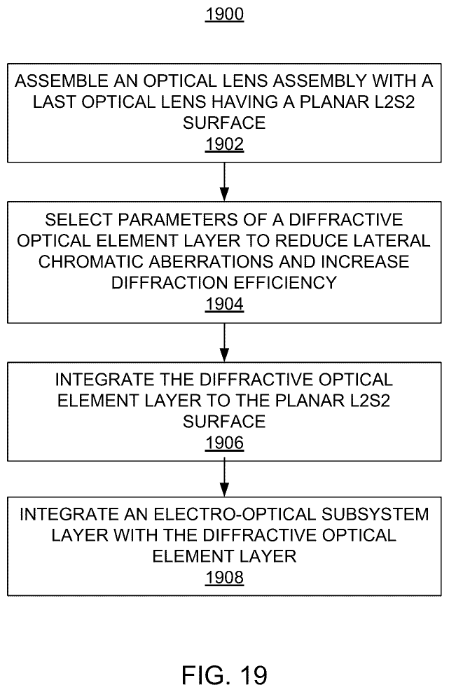

FIG. 19 illustrates a flow diagram of a method 1900 for constructing an optical lens assembly with a diffractive optical element (DOE) layer, according to an example. The method 1900 is provided by way of example, as there may be a variety of ways to carry out the method described herein. Although the method 1900 is primarily described as being performed to implement the examples of FIGS. 8, 14, and 15, the method 1900 may be executed or otherwise performed by one or more processing components of another system or a combination of systems to implement other models. Each block shown in FIG. 19 may further represent one or more processes, methods, or subroutines, and one or more of the blocks may include machine readable instructions stored on a non-transitory computer readable medium and executed by a processor or other type of processing circuit to perform one or more operations described herein.

At block 1902, an optical lens assembly may be put together with two or more optical lenses. A last lens on the eye box side may be formed or processed to have a planar L2S2 surface (surface facing the eye box).

At block 1904, design parameters of a diffractive optical element layer may be selected to reduce lateral chromatic aberration and increase a diffraction efficiency. At block 1906, the diffractive optical element layer with the selected design parameters may be applied to the planar L2S2 surface of the last optical lens in the optical lens assembly.

At block 1908, an electro-optical subsystem layer may be integrated with the diffractive optical element layer on the planar surface of the last optical lens. The electro-optical subsystem layer may include accommodation subsystems, biometrics systems, 3D sensing structures, etc. and fabricated on planar substrates.

According to examples, a method of making an optical lens assembly with a diffractive optical element (DOE) layer is described herein. A system of making the optical lens assembly with a diffractive optical element (DOE) layer is also described herein. A non-transitory computer-readable storage medium may have an executable stored thereon, which when executed instructs a processor to perform the methods described herein.

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

According to examples, an optical lens assembly may include a first optical lens toward a display of a near-eye display device, a second optical lens toward an eye box, wherein an eye box facing surface of the second optical lens is a planar surface, a diffractive optical element (DOE) layer applied to the L2S2 surface of the second optical lens, and an electro-optical subsystem layer affixed to the DOE layer. In the optical lens assembly, at least one parameter of the DOE layer is selected to at least one of reduce a chromatic aberration or increase a diffraction efficiency of the optical lens assembly. In the optical lens assembly, the increase of the diffraction efficiency of the optical lens assembly is over an operating spectral range of the near-eye display device. In the optical lens assembly, the DOE layer comprises at least one of surface-relief diffractive structures, volume holograms, polarization sensitive geometric phase diffractive structures, meta-surfaces, or liquid crystal polymers. The electro-optical subsystem layer may include at least one of an accommodation subsystem, a biometrics system, or a 3D sensing structure. In some examples, a distance between the electro-optical subsystem layer and second optical lens is reduced to prevent contrast reduction and ghosting associated with the optical lens assembly. In some examples, the optical lens assembly may include at least one additional optical lens. In some examples, the optical lens assembly may include at least one of a filter layer, a polarizer layer, a phase plate layer, or a quarter wave plate layer.

According to examples, a near-eye display device may include a virtual reality display, an eye box, and an optical lens assembly. The optical lens assembly may include a first optical lens toward the display, a second optical lens toward the eye box, wherein an eye box facing surface (L2S2 surface) of the second optical lens is a planar surface, a diffractive optical element (DOE) layer applied to the L2S2 surface of the second optical lens, and an electro-optical subsystem layer affixed to the DOE layer. In some examples, at least one parameter of the DOE layer is selected to at least one of reduce a chromatic aberration or to increase a diffraction efficiency of the optical lens assembly. In some examples, the at least one parameter of the DOE layer is selected to at least one of reduce a chromatic aberration or to increase a diffraction efficiency of the optical lens assembly over an operating spectral range of the near-eye display device. In some examples, the DOE layer comprises at least one of surface-relief diffractive structures, volume holograms, polarization sensitive geometric phase diffractive structures, meta-surfaces, or liquid crystal polymers. The electro-optical subsystem layer may include at least one of an accommodation subsystem, a biometrics system, or a 3D sensing structure.

Disclosed herein are flexible conductive polymer composites in which an electrical conduction property level of the composites may, when a current is applied through the composites, vary depending upon an amount of external mechanical stimulus applied on the composites. Thus, for instance, the composites may have a first electrical conduction property level, e.g., resistance, conductance, impedance, or the like, when the composites are in a first state, e.g., a neutral state. In addition, the composites may have a second electrical conduction property level when the composites are in a second state, e.g., an expanded or a compressed state. The composites may also have other electrical conduction property levels when the composites are in states between the first state and the second state. By way of example, the electrical conduction property level of the composites may vary progressively or proportionally to the amount of external mechanical stimulus that is applied to the composites.

According to examples, the composites may include conductive polymer units intermixed with nonconductive polymer units. Particularly, first conductive polymer units may be configured, positioned, and oriented according to a first predetermined arrangement, second conductive polymer units may be configured, positioned, and oriented according to a second predetermined arrangement, and nonconductive polymer units may be configured, positioned, and oriented according to a third predetermined arrangement. The predetermined arrangements of the first conductive polymer units, the second conductive polymer units, and the nonconductive polymer units may enable the electrical conduction property level of a composite to, when a current is applied through the composite, vary depending upon an amount of external mechanical stimulus applied on the composite.

In some examples, the composites may be employed in smartglasses, such as artificial reality (AR) and/or virtual reality (VR) glasses. In other examples, the composites may be employed in other technologies and devices.

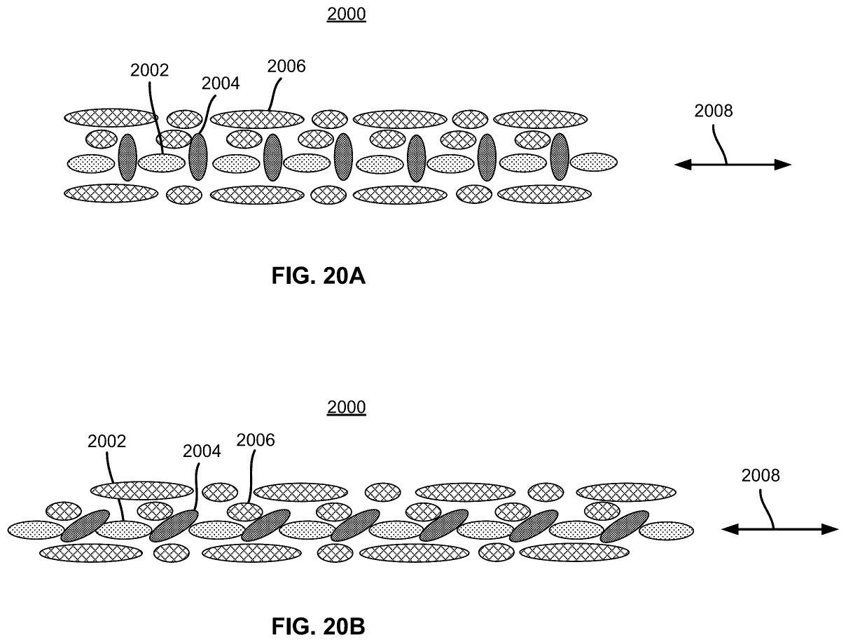

FIGS. 20A and 20B depict cross-sectional side views of a conductive polymer composite 2000 in certain expansion states, according to an example. The conductive polymer composite 2000 may also be referenced herein as a flexible conductive polymer composite 2000, a stretchable electrically conductive composite 2000, an electrically conductive polymer composite 2000, a flexible conductive polymer composite 2000, and/or the like. As used herein, a “conductive polymer” may be defined as an “electrically conductive polymer” or a polymer that allows electricity to travel through the polymer. Thus, for instance, a “conductive polymer” may be defined as a polymer that allows a measurable amount of electricity to travel through the polymer and a “nonconductive polymer” may be defined as a polymer that does not allow any measurable amount of electricity to travel through the polymer.

Generally speaking, the conductive polymer composite 2000 may utilize a combination of conductive and nonconductive polymers to enable transfer of electrical impulses in one direction (e.g., similar to a diode). The level at which the electrical implulses may be transferred may be based on the level of expansion or compression that the composite 2000 undergoes.

More particularly, the conductive polymer composite 2000 may include a combination of conductive polymer units 2002, 2004 and nonconductive polymer units 2006. According to examples, a plurality of first conductive polymer units 2002 may be configured, positioned, and oriented according to a first predetermined arrangement and a plurality of second conductive polymer units 2004 may be configured, positioned, and oriented according to a second predetermined arrangement. That is, the first conducive polymer units 2002 may have a certain configuration and may be positioned and oriented with respect to the second conductive polymer units 2004 according to a predetermined arrangement.

The first conductive polymer units 2002 may be positioned and oriented according to the first predetermined arrangement and the second conductive polymer units 2004 may be positioned and oriented according to the second predetermined arrangement when no or a minimal amount of external stimulus 2008 is applied on the composite 2000. In other words, the first conductive polymer units 2002 and the second conductive polymer units 2004 may be in their respective predetermined arrangements in the composite 2000 when the composite 2000 is in a first or a neutral state.

According to examples, the nonconductive polymer units 2006 may be positioned with respect to the first conductive polymer units 2002 and the second conductive polymer units 2004 to maintain the first conductive polymer units 2002 in the first predetermined arrangement when little or no external mechanical stimulus is applied on the composite 2000. The nonconductive polymer units 2006 may also be positioned to maintain the second conductive polymer units 2004 in the second predetermined arrangement when little or no external mechanical stimulus is applied on the composite 2000. In some examples, instead of being individual units, the nonconductive polymer units 2006 may be a nonconductive polymer section that may be arranged around portions of some of the first conductive polymer units 2002 and some of the second conductive polymer units 2004. The nonconductive polymer units 2006 may thus support the first conductive polymer units 2002 and the second conductive polymer units 2004 in their respective predetermined arrangements.

Additionally, however, the nonconductive polymer units 2006 may enable the first conductive polymer units 2002 to move with respect to the second conductive polymer units 2004 when an external mechanical movement is applied to the composite 2000. The movement may be a translational movement, a rotational movement, or a combination thereof. In some examples, the nonconductive polymer units 2006 may additionally or alternatively enable the second conductive polymer units 2004 to move with respect to the first conductive polymer units 2002.

According to examples, the first and second conductive polymer units 2002, 2004 and the nonconductive polymer units 2006 may be configured, arranged, and oriented with respect to each other to cause an electrical conduction property level of the conductive polymer composite 2000 to vary depending on an amount of external mechanical stimulus (or external mechanical energy) being applied to the composite 2000. The electrical conduction property may be, for instance, an impedance, a conductance, a resistance, and/or the like.

According to examples, the configurations, positions, and/or orientations of the conductive polymer units 2002, 2004 and the nonconductive polymer units 2006 may be selected to control the correlation between the variance in the electrical conduction property level and the amount of external mechanical stimulus applied to the composite 2000. According to examples, the conductive polymer units 2002, 2004 and the nonconductive polymer units 2006 may have certain configurations, arrangements, and/or orientations to cause the electrical conduction property level of the composite 2000 to vary progressively or proportionally with an increase in the amount of external stimulus applied to the composite 2000. That is, the conductive polymer units 2002, 2004 and the nonconductive polymer units 2006 may have certain configurations, arrangements, and/or orientations to cause the electrical conduction property level of the composite 2000 to vary in a certain manner responsive to the amount of external mechanical stimulus applied to the composite 2000. In this regard, the correlation between the electrical conduction property level of the composite 2000 and the amount of external mechanical stimulus applied to the composite 2000 may be fine-tuned.

According to examples, FIG. 20A illustrates the composite 2000 in a first or neutral state and FIG. 20B illustrates the composite 2000 in a second or expanded state. In these examples, some or all of the adjacent ones of the first conductive polymer units 2002 and the second conductive polymer units 2004 may be spaced from each other when a first amount of external mechanical stimulus is applied on the composite 2000. That is, some or all of the first conductive polymer units 2002 may not be contact with the second conductive polymer units 2004 that are adjacent to those first conductive polymer units 2002. Stated another way, some of the first conductive polymer units 2002 may be in contact with some of the second conductive polymer units 2004. However, the first amount of external mechanical stimulus may be a zero or negligible amount of external mechanical stimulus to cause sufficient contact between the first conductive polymer units 2002 and the second conductive polymer units 2004 to cause an electrical current to flow through the composite 2000 at a certain level, which may be zero or some other user-defined level.

The composite 2000 may be caused to move to the second or expanded state when an external mechanical stimulus 2008 is applied on the composite 2000. That is, the composite 2000 may be stretched outwardly by being pulled on one or more ends of the composite 2000 and/or an external force being applied longitudinally on the composite 2000. In some examples, the electrical conduction property level of the composite 2000 may increase when a current is applied through the composite 2000 as the amount of external mechanical stimulus 2008 applied on the composite 2000 increases.

For instance, the increase in the amount of external mechanical stimulus 2008 applied on the composite 2000 may increase levels of contact between the first conductive polymer units 2002 and the second conductive polymer units 2004, which may result in the increase in the conductance level through the composite 2000. Equivalently, the resistance or impedance level through the composite 2000 may decrease as the amount of external mechanical stimulus 2008 applied on the composite 2000 increases. In any regard, the electrical conduction property level, e.g., the resistance or impedance level, of the composite 2000 may progressively be reduced as a greater amount of external mechanical stimulus is applied on the composite 2000. Similarly, the conductance level of the composite 2000 may progressively be increased as a greater amount of external mechanical stimulus is applied on the composite 2000.

Likewise, a decrease in the amount of external mechanical stimulus 2008 applied on the composite 2000 may decrease levels of contact between the first conductive polymer units 2002 and the second conductive polymer units 2004, which may result in a decrease in the conductance level through the composite 2000. Equivalently, the resistance or impedance level through the composite 2000 may increase as the amount of external mechanical stimulus 2008 applied on the composite 2000 decreases.

According to examples, a first set of the first conductive polymer units 2002 and the second conductive polymer units 2004 may be positioned and oriented with respect to each other to affect the electrical conduction property level of the composite 2000 differently from a second set of the first conductive polymer units 2002 and the second conductive polymer units 2004 when an amount of external mechanical stimulus 2008 is applied on the composite 2000. For instance, the electrical conduction property level of the first set may vary at a rate that differs from a rate at which the electrical conduction property level of the second set varies. In some examples, the first set and the second set may be positioned and oriented in the composite 2000 to enable fine control of the correspondence between the electrical conduction property level of the composite 2000 and the amount of external mechanical stimulus 2008 applied on the composite 2000.

According to examples, FIG. 20B illustrates the composite 2000 in a first or neutral state and FIG. 20A illustrates the composite 2000 in a second or compressed state. In these examples, some or all of the adjacent ones of the first conductive polymer units 2002 and the second conductive polymer units 2004 may be in contact with each other when a first amount of external mechanical stimulus is applied on the composite 2000. That is, some or all of the first conductive polymer units 2002 may be in contact with the second conductive polymer units 2004 that are adjacent to those first conductive polymer units 2002. Stated another way, some of the first conductive polymer units 2002 may be in contact with some of the second conductive polymer units 2004. The first amount of external mechanical stimulus may be a zero or negligible amount of external mechanical stimulus to cause sufficient numbers of the first conductive polymer units 2002 and the second conductive polymer units 2004 to contact each other such that an electrical current is able to flow through the composite 2000 at a certain level, which may be a relatively high level or some other user-defined level.

The composite 2000 may be caused to move to the second or expanded state as shown in FIG. 20A when an external mechanical stimulus 2008 is applied on the composite 2000. That is, the composite 2000 may be compressed inwardly by one or more ends of the composite 2000 being pushed toward a center of the composite 2000. In some examples, the electrical conduction property level of the composite 2000 may increase when a current is applied through the composite 2000 as the amount of external mechanical stimulus 2008 applied on the composite 2000 increases.

For instance, the increase in the amount of external mechanical stimulus 2008 applied on the composite 2000 may decrease levels of contact between the first conductive polymer units 2002 and the second conductive polymers 2004, which may result in the decrease in the conductance level through the composite 2000. Equivalently, the resistance or impedance level through the composite 2000 may increase as the amount of external mechanical stimulus 2008 (compressive force) applied on the composite 2000 increases. In any regard, the electrical conduction property level, e.g., the resistance or impedance level, of the composite 2000 may progressively be increased as a greater amount of external mechanical stimulus (compressive force) is applied on the composite 2000. Similarly, the conductance level of the composite 2000 may progressively be decreased as a greater amount of external mechanical stimulus is applied on the composite 2000.

Likewise, an increase in the amount of external mechanical stimulus 2008 applied on the composite 2000 may decrease levels of contact between the first conductive polymer units 2002 and the second conductive polymers 2004, which may result in a decrease in the conductance level through the composite 2000. Equivalently, the resistance or impedance level through the composite 2000 may increase as the amount of external mechanical stimulus 2008 applied on the composite 2000 increases.

In any of these examples, the nonconductive polymer units 2006 may have any of a variety of shapes and sizes and may be positioned on or around some or all of the first conductive polymer units 2002 and the second conductive polymer units 2004. The nonconductive polymer units 2006 may include individual units, a continuous unit, or a combination thereof. The nonconductive polymer units 2006 may support the first conductive polymer units 2002 such that the first conductive polymer units 2002 may be arranged according to the first predetermined arrangement. The nonconductive polymer units 2006 may also support the second conductive polymer units 2004 such that the first conductive polymer units 2002 may be arranged according to the second predetermined arrangement.

The nonconductive polymer units 2006 may provide mechanical properties to the composite 2000. Additionally, the nonconductive polymer units 2006 may prevent electrical current from leaking out from the composite 2000 and into an external environment. The nonconductive polymer units 2006 may also prevent electrical current from the external environment from entering into the first and second conductive polymer units 2002, 2004.

Additionally, the nonconductive polymer units 2006 may be configured, positioned, and oriented with respect to the first conductive polymer units 2002 and/or the second conductive polymer units 2004 to move, e.g., translate and/or rotate, in a predetermined manner as an external mechanical stimulus 2008 is applied on the composite 2000. The translation and/or rotation of the first conductive polymer units 2002 and/or the second conductive polymer units 2004 may cause greater or lesser levels of contact between some or all of the first conductive polymer units 2002 and/or the second conductive polymer units 2004. In other words, the nonconductive polymer units 2006 may be configured, positioned, and oriented to enable stronger or weaker electrical conductance through the composite 2000 as the external mechanical stimulus 2008 is applied on the composite 2000.

In some examples, some of the nonconductive polymer units 2006 may have a configuration, orientation, position, and/or the like that differs from other ones of the nonconductive polymer units 2006. Some of the nonconductive polymer units 2006 may have the different features to enable the intended variances in the electrical conduction property level caused by changes in the amount of external mechanical stimulus 2008 applied on the composite 2000.

The nonconductive polymer units 2006 may include any suitable type of flexible polymer material that does not conduct electrical current. In other words, the nonconductive polymer units 2006 may be a flexible polymer material that may function as an electrical insulator. In some examples, the nonconductive polymer units 2006 may be formed of a suitable type of flexible nonconductive polymer material that provides sufficient mechanical support to the composite 2000. For instance, the nonconductive polymer material may include polyethylene terephthalate (PET), nylon, polyester, or the like.

According to examples, a first set of the first conductive polymer units 2002 and the second conductive polymer units 2004 may be positioned and oriented with respect to each other to affect the electrical conduction property level of the composite 2000 differently from a second set of the first conductive polymer units 2002 and the second conductive polymer units 2004 when an amount of external mechanical stimulus 2008 is applied on the composite 2000. For instance, the electrical conduction property level of the first set may vary at a rate that differs from a rate at which the electrical conduction property level of the second set varies. In some examples, the first set and the second set may be positioned and oriented with respect to each other to enable fine control of the correspondence between the electrical conduction property level of the composite 2000 and the amount of external mechanical stimulus 2008 applied on the composite 2000.

In some examples, the first conductive polymer units 2002 and the second conductive polymer units 2004 may be formed of a common, e.g., a same, polymer material. In other examples, the first conductive polymer units 2002 may be formed of a first type of polymer material and the second conductive polymer units 2004 may be formed of a second type of polymer material, in which the second type of polymer material differs from the first type of polymer material. In yet other examples, the composite 2000 may include one or more additional conductive polymer units (not shown), in which the one or more additional conductive polymer units assist in the control of the variance in the electrical conduction property level of the composite 2000 responsive to the amount of externa mechanical stimulus applied on the composite 2000. The one or more additional conductive polymer units may include polymer materials that are the same as the first conductive polymer units 2002 and/or the second conductive polymer units 2004 or may differ from the types of materials forming the first conductive polymer units 2002 and/or the second conductive polymer units 2004.

According to examples, the first conductive polymer units 2002, the second conductive polymer units 2004, and/or any additional conductive polymer units may be formed of organic polymers that may conduct electricity. Examples of suitable materials include poly(3,4-ethylenedioxythiophene) polystyrene sulfonate (PEDOT:PSS), polyaniline, polypyrrole, and/or the like. In some examples, the first conductive polymer units 2002 may be formed of an electrically conductive polymer material that differs in flexibility and/or stretchability from the second conductive polymer units 2004. In these examples, the materials for the first conductive polymer units 2002 and the materials for the second conductive polymer units 2004 may be selected to enable the composite 2000 to have intended electrical conduction properties during application of various amounts of external mechanical stimuli 108 on the composite 2000. The material for the nonconductive polymer units 2006 may be selected for similar reasons.

According to examples, and as shown in FIG. 20A, the first conductive polymer units 2002 may have elongated shapes and may be positioned and oriented according to the first predetermined arrangement. Additionally, in the first predetermined arrangement, the first conductive polymer units 2002 may be arranged to extend in a first direction. In other words, the first conductive polymer units 2002 may be arranged such that the first conductive polymer units 2002 are at a first angle.

As also shown in FIG. 20A, the second conductive polymer units 2004 may have elongated shapes and may be positioned and oriented according to the second predetermined arrangement. Additionally, in the second predetermined arrangement, the second conductive polymer units 2004 may be arranged to extend in a second direction. In other words, the second conductive polymer units 2004 may be arranged such that the second conductive polymer units 2004 are at a second angle. The second direction and the second angle may respectively differ from the first direction and the first angle.

By way of particular example, and as shown in FIG. 20A, when the composite 2000 is in a neutral position, e.g., when a negligible or zero amount of an external mechanical stimulus 2008 is applied on the composite 2000, most or all of the first conductive polymer units 2002 may be spaced from adjacent or neighboring second conductive polymer units 2004. As a result, an attempt to conduct electricity through the composite 2000 may be unsuccessful. As shown in FIG. 20B, when a greater amount of external mechanical stimulus 2008 is applied on the composite 2000, the composite 2000 may stretch or expand, which may cause a greater number of the first conductive polymer units 2002 to contact some or all of the second conductive polymer units 2004 that are adjacent to the first conductive polymer units 2002. As a result, electricity may more readily flow through the composite 2000 via the first conductive polymer units 2002 and the second conductive polymer units 2004. Upon relaxation/release of the external mechanical stimulus 2008, the composite 2000 may return back to the neutral position (FIG. 20A), thereby returning the composite 2000 to a nonconductive state.

As another example, a compressive external mechanical stimulus 2008 may be applied on the composite 2000 shown in FIG. 20A, which may cause a greater number of the first conductive polymer units 2002 to contact some or all of the second conductive polymer units 2004 that are adjacent to the first conductive polymer units 2002. As a result, electricity may more readily flow through the composite 2000 via the first conductive polymer units 2002 and the second conductive polymer units 2004. Upon relaxation/release of the external mechanical stimulus 2008, the composite 2000 may return back to the neutral position (FIG. 20A), thereby returning the composite 2000 to a nonconductive state.

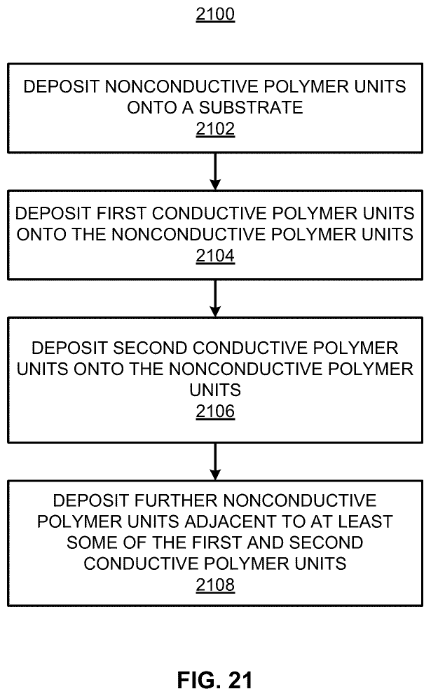

FIG. 21 illustrates a flow diagram of a method 2100 for forming a flexible conductive polymer composite 2000, according to an example. It should be understood that the method 2100 depicted in FIG. 21 may include additional operations and that some of the operations described therein may be removed and/or modified without departing from the scope of the method 2100. The description of the method 2100 is made with reference to the features depicted in FIGS. 20A and 20B for purposes of illustration.

At block 2102, a plurality of nonconductive polymer units 2006 may be deposited onto a substrate (not shown), which may be a work surface, a platform, or the like. For instance, one or more layers of the nonconductive polymer units 2006 may be deposited onto the substrate, in which the one or more layers may form a bottom portion or a top portion of the composite 2000.

At block 2104, a plurality of first conductive polymer units 2002 may be deposited onto the deposited nonconductive polymer units 2006. In addition, at block 2106, a plurality of second conductive polymer units 2004 may be deposited onto the deposited nonconductive polymer units.

According to examples, the first conductive polymer units 2002, the second conductive polymer units 2006, and the nonconductive polymer units 2006 may be deposited to have configurations, positions, and orientations that correspond to a predetermined arrangement in which the composite 2000 has a first predefined electrical conduction property level when in a neutral state and has a second predefined electrical conduction property level when an external mechanical stimulus is applied on the composite 2000. In other words, the first conductive polymer units 2002, the second conductive polymer units 2004, and the nonconductive polymer units 2006 may be deposited to have certain configurations and to be positioned with respect to each other to cause the composite 2000 to have the predefined electrical conduction property levels as discussed herein.

In some examples, the configurations, positions, and orientations of the first conductive polymer units 2002, the second conductive polymer units 2004, and the nonconductive polymer units 2006 that may result in the intended electrical conduction property levels may be predefined. The configurations, positions, and orientations that may result in the intended electrical conduction property levels may be determined through computer modeling and/or testing.

According to examples, the first conductive polymer units 2002, the second conductive polymer units 2004, and the nonconductive polymer units 2006 may be deposited to have configurations, positions, and orientations that cause the composite 2000 to be nonconductive when the composite 2000 is in the neutral state and for the electrical conduction property level to progressively change as an amount of external mechanical stimulus 2008 applied to the composite 2000 increases. For instance, the electrical conduction property level, e.g., the conductance level, may progressively increase as an amount of external mechanical stimulus 2008 applied to the composite 2000 increases. As another example, the electrical conduction property level, e.g., the impedance level or the resistance level, may progressively decrease as an amount of external mechanical stimulus 2008 applied to the composite 2000 increases.

According to examples, the first conductive polymer units 2002, the second conductive polymer units 2004, and the nonconductive polymer units 2006 may be deposited to have configurations, positions, and orientations that cause the composite 2000 to be electrically conductive when the composite 2000 is in the neutral state and for the electrical conduction property level to progressively change as an amount of external mechanical stimulus 2008 applied to the composite increases. For instance, the electrical conduction property level, e.g., the conductance level, may progressively decrease as an amount of external mechanical stimulus 2008 applied to the composite 2000 increases. As another example, the electrical conduction property level, e.g., the impedance level or the resistance level, may progressively increase as an amount of external mechanical stimulus 2008 applied to the composite 2000 increases.

According to examples, the first conductive polymer units 2002, the second conductive polymer units 2004, and the nonconductive polymer units 2006 may be deposited through any suitable deposition process. For instance, a sputtering, thermal evaporation, chemical vapor deposition, atomic layer deposition, electrochemical deposition, electron beam deposition, Langmuir-Blodgett deposition, colloidal deposition, and/or the like, technique may be employed to deposit the polymer units 2002-2006. In addition, masking techniques may be employed to deposit the polymer units 2002-2006 to have intended configurations and at intended locations and orientations with respect to each other. As other examples, a three-dimensional (3D) printing system may be employed to selectively deposit the polymer units 2002-2006 at their intended configurations, locations, and orientations.

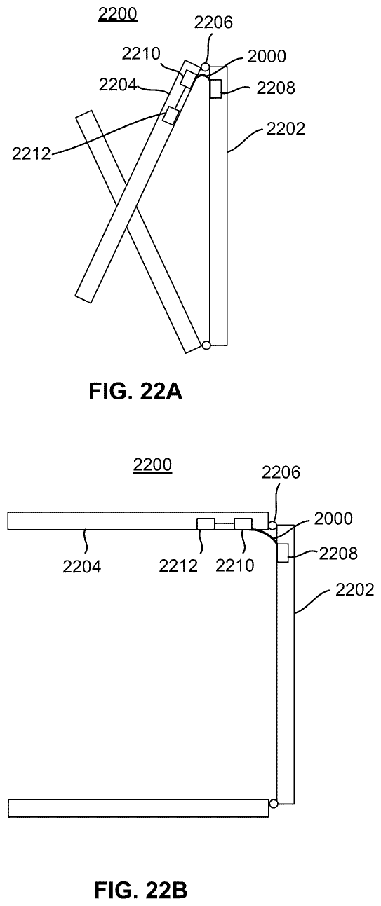

FIGS. 22A and 22B, respectively, depict top views of a head mounted device 2200 including a flexible conductive polymer composite 2000, according to an example. The head mounted device 2200 may be eyeglasses or smartglasses (e.g., artificial reality glasses, virtual reality glasses, or the like). The head mounted device 2200 may include a frame 2202 and a pair of temple arms 2204, in which the temple arms 2204 may be rotatable with respect to the frame 2202. For instance, the head mounted device 2200 may include hinges 2206 to which the frame 2202 and the temple arms 2204 may be attached and which may enable the rotational movement of the temple arms 2204 with respect to the frame 2202.

FIG. 22A illustrates the head mounted device 2200 in a state in which the temple arms 2204 are folded in toward the frame 2202. Thus, for instance, FIG. 22A illustrates a state in which the head mounted device 2200 may be stored in a case. As shown, the flexible conductive polymer composite 2000 may be connected to the frame 2202 and one of the temple arms 2204. Particularly, for instance, one end of the flexible conductive polymer composite 2000 may be connected to an electronic component 2208 in the frame 2202 and another electronic component 2210 in the temple arm 2204. Each of the electronic components 2208, 2210 may be, for example, a sensor, an integrated circuit (IC), a printed circuit board (PCB), a multi-layer board (MLB), a battery, a speaker, a touch sensor for user interaction, and/or the like. By way of particular example, the electronic components 2208, 2210 may be connected to an eye tracking system, a display, and/or the like.

In some examples, the conductive polymer composite 2000 may be in a neutral state (as shown in FIG. 20A) when the temple arm 2204 is folded as shown in FIG. 22A. In other words, an external mechanical stimulus may not be applied to the conductive polymer composite 2000 when the temple arm 2204 is folded as shown in FIG. 22A. In the neutral state, for instance, the conductive polymer composite 2000 may be nonconductive and thus, electricity may not flow between the electronic components 2208, 2210 in the frame 2202 and the temple arm 2204.

FIG. 22B illustrates the head mounted device 2200 in a state in which the temple arms 2204 are in an open position with respect to the frame 2202. Thus, for instance, FIG. 22B illustrates a state in which a user may place the head mounted device 2200 in front of their eyes for use of the head mounted device 2200. As shown, the flexible conductive polymer composite 2000 may be in an expanded or stretched state when the temple arm 2204 is in the open position, for instance, as shown in FIG. 20B. As a result, an external mechanical stimulus 2008 may be applied on the flexible conductive polymer composite 2000 and the flexible conductive polymer composite 2000 may be conductive. Additionally, electricity may flow between the electronic component 2208 in the frame 2202 and the electronic component 2210 in the temple arm 2204.

By way of particular example, the closing or folding of the temple arms 2204, may cause electricity to stop flowing between the electronic components 2208, 2210, which may signal a controller 2212 to enter into a sleep mode, to shut down, or the like. As a result, the flexible conductive polymer composite 2000 may be employed to reduce or minimize energy usage of electronic components in the head mounted device 2200.

According to other examples, the flexible conductive polymer composite 2000 disclosed herein may find use in other fields or devices. For instance, the flexible conductive polymer composite 2000 may be employed in physiotherapy through a real time monitoring of a patient's response to prescribed movements. The flexible conductive polymer composite 2000 may be employed in gloves and/or clothing to generate real time monitoring of various parts of a user during movement, for instance, of athletes. The flexible conductive polymer composite 2000 may be incorporated into shoes and may be used to identify walking/running patterns of a wearer of the shoes. As another example, the flexible conductive polymer composite 2000 may be employed in medical applications such as sensors. As a further example, the flexible conductive polymer composite 2000 may be employed to optimize a vocal performance of a singer. As a yet further example, the flexible conductive polymer composite 2000 may be employed in the training of service animals. As a yet further example, the flexible conductive polymer composite 2000 may be employed may be employed as a pressure sensitive floor sensor, e.g. in a carpet liner. The pressure sensitive floor sensor may have security applications.

A flexible conductive polymer composite may include a plurality of first conductive polymer units configured, positioned, and oriented according to a first predetermined arrangement, a plurality of second conductive polymer units configured, positioned, and oriented according to a second predetermined arrangement, and a plurality of nonconductive polymer units configured, positioned, and oriented according to third predetermined arrangement, wherein the first conductive polymer units, the second conductive polymer units, and the nonconductive polymer units are positioned with respect to each other in the composite to cause an electrical conduction property level of the composite to, when a current is applied through the composite, vary depending upon an amount of external mechanical stimulus applied on the composite. In some examples, when a first amount of external mechanical stimulus is applied on the composite, the first conductive polymer units are positioned and oriented according to the first predetermined arrangement, the second conductive polymer units are positioned and oriented according to the second predetermined arrangement, and the nonconductive polymer units are positioned and oriented according to the third predetermined arrangement.

In some examples, adjacent ones of the first conductive polymer units and the second conductive polymer units are spaced from each other when the first amount of external mechanical stimulus is applied on the composite. In some examples, adjacent ones of the first conductive polymer units and the second conductive polymer units are positioned and oriented to cause the electrical conduction property level of the composite to progressively be reduced as a greater amount of external mechanical stimulus is applied on the composite. In some examples, adjacent ones of the first conductive polymer units and the second conductive polymer units are in contact with each other when a greater amount of external mechanical stimulus is applied on the composite. Adjacent ones of the first conductive polymer units and the second conductive polymer units may be positioned and oriented to cause the electrical conduction property level of the composite to progressively be increased as a greater amount of external mechanical stimulus is applied on the composite.

In some examples, a first set of the first conductive polymer units and the second conductive polymer units are positioned and oriented with respect to each other to affect the electrical conduction property level of the composite differently from a second set of the first conductive polymer units and the second conductive polymer units when an amount of external mechanical stimulus is applied on the composite. The nonconductive polymer units may be positioned and oriented with respect to the first conductive polymer units and the second conductive polymer units to assist in positioning either or both of adjacent ones of the first conductive polymer units and the second conductive polymers to vary the electrical conduction property level of the composited as amounts of external mechanical stimulus applied on the composite is varied.

In some examples, the first conductive polymer units and the second conductive polymer units are formed of a common polymer material. In other examples, the first conductive polymer units are formed of a first type of polymer material and the second conductive polymer units are formed of a second type of polymer material, wherein the second type of polymer material differs from the first type of polymer material.

According to examples, a flexible conductive polymer composite may include a plurality of first conductive polymer units having elongated shapes, the first conductive polymer units being positioned and oriented according to a first predetermined arrangement in which the first conductive polymer units are arranged to extend in a first direction, a plurality of second conductive polymer units having elongated shapes, the second conductive polymer units being positioned and oriented according to a second predetermined arrangement in which the second conductive polymer units are arranged to extend in a second direction, wherein the second direction differs from the first direction, and a nonconductive polymer section arranged around portions of some of the first conductive polymer units and the second conductive polymer units, wherein the nonconductive polymer section supports the first conductive polymer units in the first predetermined arrangement and the second conductive polymer units in the second predetermined arrangement when the composite is in a first state and causes at least some of the first conductive polymer units to move with respect to at least some of the second conductive polymer units when an external mechanical stimulus is applied on the composite, wherein an electrical conduction property level of the composite varies progressively with an amount of external mechanical stimulus applied on the composite.

The first state may be an unstretched state and the composite is to be stretched when the external mechanical stimulus is applied on the composite, and wherein the electrical conduction property level of the composite progressively decreases as the amount of external mechanical stimulus applied on the composite increases. The first state may be an unstretched state and the composite is to be stretched when the external mechanical stimulus is applied on the composite, and wherein the electrical conduction property level of the composite progressively increases as the amount of external mechanical stimulus applied on the composite increases. The first state may be an expanded state and the composite is to be compressed when the external mechanical stimulus is applied on the composite, and wherein the electrical conduction property level of the composite progressively decreases as the amount of external mechanical stimulus applied on the composite increases.

The electrical conduction property level of the composite may progressively increase as the level of external mechanical stimulus on the composite increases. The first conductive polymer units may be formed of a first type of polymer material and the second conductive polymer units may be formed of a second type of polymer material, wherein the second type of polymer material differs from the first type of polymer material.

A method for forming a flexible conductive polymer composite, in which the method includes depositing a plurality of nonconductive polymer units onto a substrate, depositing a plurality of first conductive polymer units onto the deposited nonconductive polymer units, and depositing a plurality of second conductive polymer units onto the deposited nonconductive polymer units, wherein the first conductive polymer units, the second conductive polymer units, and the nonconductive polymer units are deposited to have configurations, positions, and orientations that correspond to a predetermined arrangement in which the composite has a first predefined electrical conduction property level when in a neutral state and has a second predefined electrical conduction property level when an external mechanical stimulus is applied on the composite.

The method may further include depositing a further plurality of nonconductive polymer units adjacent to at least some of the first conductive polymer units and at least some of the second conductive polymer units. The first conductive polymer units, the second conductive polymer units, and the nonconductive polymer units may be deposited to have configurations, positions, and orientations that cause the composite to be nonconductive when the composite is in the neutral state and for the electrical conduction property level to progressively change as an amount of external mechanical stimulus applied to the composite increases. The method first conductive polymer units, the second conductive polymer units, and the nonconductive polymer units may be deposited to have configurations, positions, and orientations that cause the composite to be electrically conductive when the composite is in the neutral state and for the electrical conduction property level to progressively change as an amount of external mechanical stimulus applied to the composite increases.

Users of social media applications often capture media, e.g., photos and videos, and upload the captured media to the social media applications to share with friends and followers. Oftentimes, the media is tagged with location information such that the media may be displayed on a map according to the locations at which the media were captured. Typically, the devices that are used to capture the media, such as smartphones, include a global positioning system (GPS) receiver that tracks the locations of the devices. Other types of devices, for instance, those that may not be equipped with a GPS receiver, may employ wireless fidelity (WiFi) based positioning techniques.

There are, however, some drawbacks to the use of GPS receivers and WiFi-based positioning techniques. For instance, in many situations, such as when the user is indoors or at a remote location where GPS signals may not be sufficiently strong, the GPS receivers may be unable to determine their locations. Additionally, it may not be practical to employ GPS receivers in certain types of devices, such as smartglasses, due to the amount of space used and the amount of energy consumed by the GPS receivers. The implementation of WiFi-based positioning techniques on such devices may also suffer from some drawbacks as this technique may require a relatively large amount of energy, which may quickly drain batteries on the devices. Additionally, the WiFi-based positioning techniques may require that the devices maintain connectivity for network calls, which may sometimes be poor when the media is captured.

Disclosed herein are wearable devices, such as wearable eyewear, smartglasses, head-mountable devices, etc., that enable the locations at which media have been captured by the wearable devices to be identified. The captured media may be tagged with those locations, e.g., geotagged, by including those locations in the metadata of the media. As discussed herein, the locations may be determined without the use of a Global Positioning System (GPS) receiver on the wearable devices and without performing WiFi-based positioning techniques on the wearable devices. Instead, the locations may be determined with the assistance of computing apparatuses that are unpaired with the wearable devices. In other words, the determination of the locations may be crowdsourced to unspecified computing apparatuses that are within range of the wearable devices to receive short-range wireless communication signals from the wearable devices.

In some examples, a controller of a wearable device may determine that an imaging component has captured a media and may tag the captured media with a code. The code may differ from an identifier of the wearable device and thus, the code may not be used to identify the wearable device. Instead, the code may be a unique code that may be used to identify geolocation information of the media, e.g., to geotag the media. That is, based on a determination that the imaging component has captured the media, the controller may cause at least one wireless communication component to wireless transmit the code to one or more unspecified computing apparatuses. A computing apparatus that receives the code may send the code along with geolocation information of the computing apparatus to a server, and the server may store that code and the geolocation information. The computing apparatus may not send an identifier of the computing apparatus to the server and thus, the identity of the computing apparatus may remain secret from the server.

At a later time, e.g., after the wearable device is paired with a certain computing apparatus, the controller may send the media and the code to the certain computing apparatus. The certain computing apparatus may also send a request to the server for the geolocation information, in which the request may include the code. The server may use the code, and in some instances, a timestamp associated with the geolocation information, to identify the geolocation information corresponding to the code. The server may also return the geolocation information to the certain computing apparatus. In addition, the certain computing apparatus may associate, e.g., tag or embed, the media with the geolocation information, e.g., geotag the media.

Through implementation of the features of the present disclosure, media captured by wearable devices may be geotagged in simple and energy-efficient manners. That is, media captured by wearable devices, such as smartglasses, may be geotagged without consuming a relatively large amount of energy from batteries contained in the wearable devices. A technical improvement afforded through implementation of the features of the present disclosure may be that media may be geotagged without having to use GPS receivers or WiFi positioning techniques on the wearable devices, which may reduce energy consumption in the wearable devices.

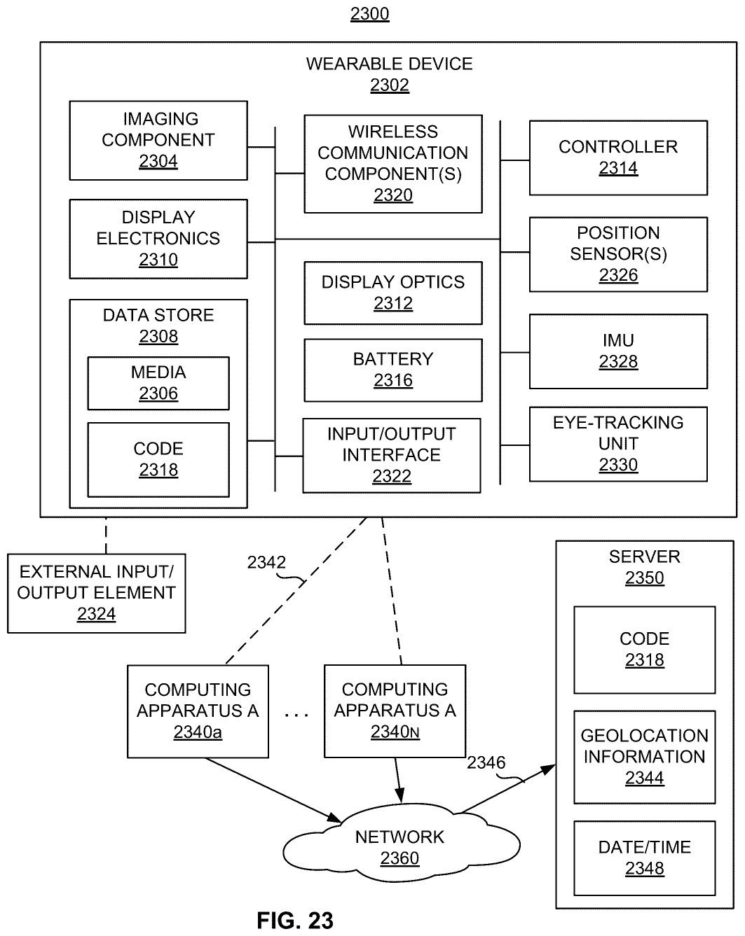

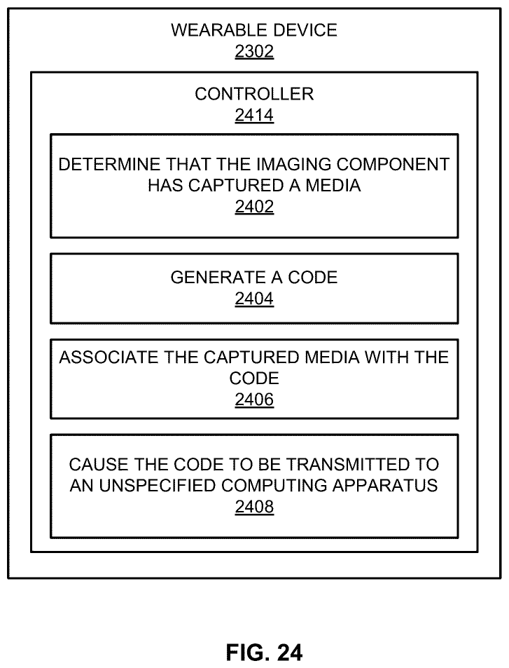

Reference is made to FIGS. 23 and 24. FIG. 23 illustrates a block diagram of an environment 2300 including a wearable device 2302 having an imaging component 2304, according to an example. FIG. 24 illustrates a block diagram of the wearable device 2302 depicted in FIG. 23, according to an example. The wearable device 2302 may be a “near-eye display”, which may refer to a device (e.g., an optical device) that may be in close proximity to a user's eye. As used herein, “artificial reality” may refer to aspects of, among other things, a “metaverse” or an environment of real and virtual elements, and may include use of technologies associated with virtual reality (VR), augmented reality (AR), and/or mixed reality (MR). As used herein a “user” may refer to a user or wearer of a “near-eye display.”

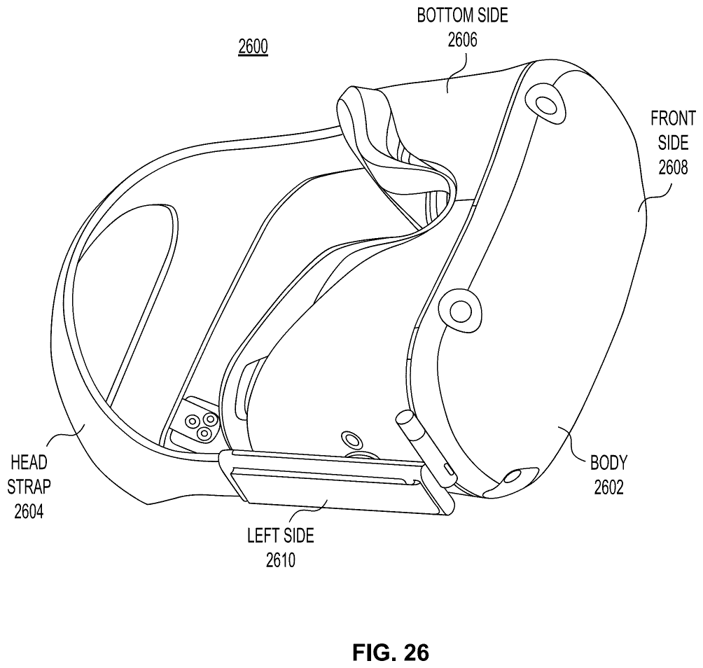

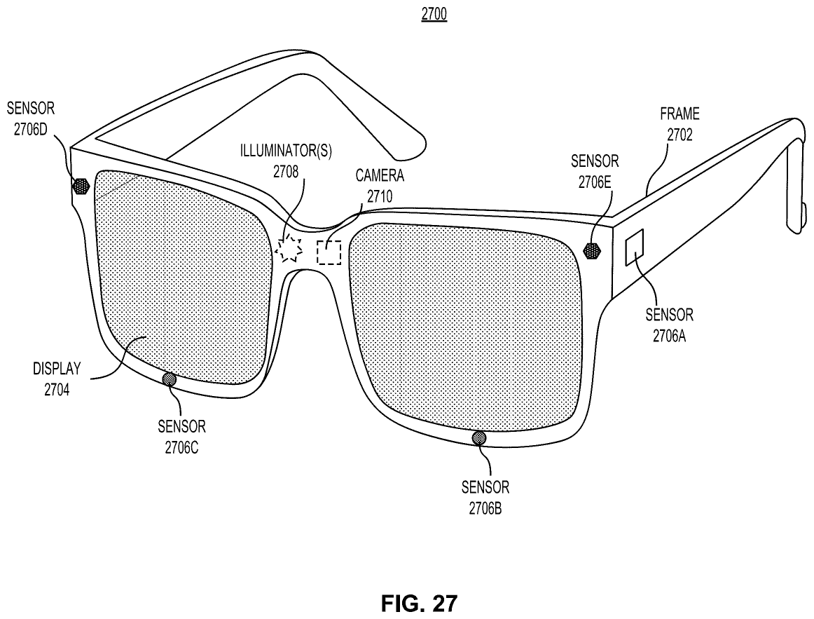

The wearable device 2302 may be a wearable eyewear such as a wearable headset, smart glasses, a head-mountable device, eyeglasses, or the like. Examples of wearable devices 2302 are depicted in FIGS. 26 and 27 and are described in greater detail herein below. In FIG. 23, the wearable device 2302 is depicted as including an imaging component 2304 through which media 2306, e.g., images and/or videos, may be captured. For instance, a user of the wearable device 2302 may control the imaging component 2304 to capture an image or video that is imaged through the imaging component 2304, which may correspond to a viewing area of the imaging component 2304. The imaging component 2304 may include a sensor or other device that may absorb light captured through one or more lenses. The absorbed light may be converted into electrical signals that may be stored as data representing the media 2306. The data, which is also referenced herein as the media 2306, representing the media 2306 may be stored in a data store 2308 of the wearable device 2302.

The data store 2308 may be locally contained in the wearable device 2302. In some examples, the data store 2308 may be a Read Only Memory (ROM), a flash memory, a solid state drive, a Random Access memory (RAM), an Electrically Erasable Programmable Read-Only Memory (EEPROM), a storage device, or the like. In some examples, the data store 2308 may have stored thereon instructions (shown in FIG. 24) that the controller 2314 may execute as discussed herein.

The wearable device 2302 is also depicted as including display electronics 2310 and display optics 2312. The display electronics 2310 and the display optics 2312 may be optional in that, in some examples, the wearable device 2302 may not display images, but instead, may include lenses, in which a user may see through the lenses. These wearable devices 2302 may be eyeglasses or sunglasses. In some examples in which the wearable device 2302 includes the display electronics 2310 and the display optics 2312, the display electronics 2310 may display or facilitate the display of images to the user according to received data. For instance, the display electronics 2310 may receive data from the imaging component 2304 and may facilitate the display of images captured by the imaging component 2304. The display electronics 2310 may also or alternatively display images, such as graphical user interfaces, videos, still images, etc., from other sources. The other sources may include the data store 2308, a computing apparatus that is paired with the wearable device 2302, a server via the Internet, and/or the like.

In some examples, the display electronics 2310 may include one or more display panels or projectors that may include a number of pixels to emit light of a predominant color such as red, green, blue, white, or yellow. In some examples, the display electronics 2310 may display a three-dimensional (3D) image, e.g., using stereoscopic effects produced by two-dimensional panels, to create a subjective perception of image depth.

In some examples, the display optics 2312 may display image content optically (e.g., using optical waveguides and/or couplers) or magnify image light received from the display electronics 2310, correct optical errors associated with the image light, and/or present the corrected image light to a user of the wearable device 2302. In some examples, the display optics 2312 may include a single optical element or any number of combinations of various optical elements as well as mechanical couplings to maintain relative spacing and orientation of the optical elements in the combination. In some examples, one or more optical elements in the display optics 2312 may have an optical coating, such as an anti-reflective coating, a reflective coating, a filtering coating, and/or a combination of different optical coatings.

In some examples, the display optics 2312 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

As also shown in FIG. 23, the wearable device 2302 may include a controller 2314 that may control operations of various components of the wearable device 2302. The controller 2314 may be a semiconductor-based microprocessor, a central processing unit (CPU), an application-specific integrated circuit (ASIC), a field-programmable gate array (FPGA), and/or other hardware device. The controller 2314 may be programmed with software and/or firmware that the controller 2314 may execute to control operations of the components of the wearable device 2302. For instance, the controller 2314 may execute instructions to cause the imaging component 2304 to capture media 2306, e.g., still and/or video images. In some examples, the controller 2314 may execute instructions to cause the display electronics 2310 to display the media 2306 on the display optics 2312. By way of example, the displayed images may be used to provide a user of the wearable device 2302 with an augmented reality experience such as by being able to view images of the user's surrounding environment along with other displayed images.

FIG. 23 further shows the wearable device 2302 as including a battery 2316, which may be a rechargeable battery. When the wearable device 2302 is not connected to an external power source, the battery 2316 provides power to the components in the wearable device 2302. In order to reduce or minimize the size and weight of the wearable device 2302, the battery 2316 may have a relatively small form factor and may thus provide relatively limited amount of power to the wearable device 2302.

In many instances, users of the wearable device 2302 may wish to capture media 2306 and to tag the captured media 2306 with geolocation information or data, which may be referenced to herein as geotagging the captured media 2306. The geolocation data may be geographic coordinate data, such as latitude and longitude coordinates. The geolocation data may also or alternatively include place names, such as country name, city name, street name, business name, etc. In other words, users may wish to geotag the captured media 2306 such that, for instance, the locations at which the media 2306 were captured may be identified from the media 2306. The geotag may be included in metadata of the media 2306 such that, for instance, the location information may be used in identifying images captured at or near certain locations. The location information may also be used to display the media 2306 on maps at the approximate locations at which the media were captured.

In order to geotag the media, identification of the locations at which the media 2306 are captured may be required. In many instances, it may be undesirable to include a global positioning system (GPS) receiver in the wearable device 2302 because the GPS receiver may consume a relatively large amount of power from the battery 2316 and may take up a relatively large amount of space in the wearable device 2302. Additionally, even when the wearable device 2302 is equipped with a GPS receiver, the GPS receiver may not work consistently when the wearable device 2302 is indoors.

According to examples, and as shown in FIG. 24, the controller 2314 may execute instructions 2402-2408 that are intended to enable the locations at which media 2306 have been captured to be determined without the use of a GPS receiver on the wearable device 2302. The instructions 2402-2408 may be software and/or firmware. In some examples, the controller 2314 may execute the instructions 2402 to determine that the imaging component 2304 has captured a media 2306. The controller 2314 may determine that the imaging component 2304 has captured the media 2306 based on a determination that the imaging component 2304 has been activated to capture one or more images. In other examples, the controller 2314 may determine that the imaging component 2304 has captured the media 2306 based on a determination that the media 2306 has been stored on a data store 2308. In yet other examples, the controller 2314 may determine that the imaging component 2304 has captured the media 2306 based on receipt of an input from a user regarding the capture of the media 2306. The controller 2314 may also make this determination in other manners.

The controller 2314 may execute the instructions 2404 to generate a code 2318. The code 2318 may be any suitable code or key, e.g., a set or string of characters including numbers, letters, symbols, and/or the like, that may later be used to identify media 2306 captured by the imaging component 2304 of the wearable device 2302. In some examples, the code 2318 may differ from an identifier, such as a serial number or other identification, of the wearable device 2302. In this regard, the code 2318 may not be used to identify the wearable device 2302. Instead, the code 2318 may be derived from the identifier of the wearable device 2302, randomly generated, derived from another factor such as the date and time at which the media 2306 was captured, and/or the like.

In some examples, the controller 2314 may generate the code 2318 prior to the determination that the imaging component 2304 has captured the media 2306. In other examples, the controller 2314 may generate the code 2318 following the determination that the imaging component 2304 has captured the media 2306. In some examples, the controller 2314 may generate the code 2318 once and may reuse the code 2318 for multiple media 2306. In other examples, the controller 2314 may generate a new code 2318 for each newly captured media 2306 or a new code 2318 for certain ones of the captured media 2306. For instance, the controller 2314 may generate a new code 2318 for media 2306 that have been captured after a certain length of time after a previous media 2306 has been captured. In this regard, the same code 2318 may be used for media 2306 that have been captured around the same time with respect to each other.

The controller 2314 may execute the instructions 2406 to associate the captured media 2306 with the code 2318. The controller 2314 may associate the captured media 2306 by including the code 2318 in the metadata of the captured media 2306. For instance, the controller 2314 may generate the metadata as an exchangeable image file format (EXIF) file in which the media 2306 metadata may include text information pertaining to a file of the media 2306, details relevant to the media 2306, information about production of the media 2306, and/or the like. In some examples, the controller 2314 may embed or otherwise insert the code 2318 in a field of the media 2306 metadata. In other examples, the controller 2314 may associate the captured media 2306 by storing the code 2318 in the data store 2308 along with an indication that the code 2318 corresponds to or is otherwise related to the captured media 2306.

The controller 2314 may execute the instructions 2408 to cause the code 2318 to be transmitted to an unspecified computing apparatus 2340a, as represented by the dashed lines 2342. Particularly, the controller 2314 may transmit the code 2318 as a broadcast signal to computing apparatuses 2340a-2340n that are within range of one or more wireless communication components 2320 in the wearable device 2302. In other words, the controller 2314 may control the wireless communication component(s) 2320 to transmit the code 2318 to a computing apparatus 2340a-2340n to which the wearable device 2302 is not paired. Put another way, the wearable device 2302 may not be paired, e.g., paired via a Bluetooth™ connection, with any of the computing apparatuses 2340a-2340n that are within range of the wearable device 2302.

The wireless communication component(s) 2320 in the wearable device 2302 may include one or more antennas and any other components and/or software to enable wireless transmission and receipt of radio waves. For instance, the wireless communication component(s) 2320 may include an antenna through which wireless fidelity (WiFi) signals may be transmitted and received. As another example, the wireless communication component(s) 2320 may include an antenna through which Bluetooth™ signals may be transmitted and received. As a yet further example, the wireless communication component(s) 2320 may include an antenna through which cellular signals may be transmitted and received.

According to examples, the controller 2314 may cause the code 2318 to be transmitted without also transmitting the media 2306. As discussed herein, the code 2318 may not be used to identify the wearable device 2302. In this regard, the identity of the wearable device 2302, information regarding the user of the wearable device 2302, and the media 2306 may remain private from any computing apparatuses 2340a-2340n that may have received the code 2318 from the wearable device 2302.

In some examples, the wireless communication component(s) 2320 may include a short-range antenna that is to output signals a relatively short range. For instance, the short-range antenna may output signals approximately 30 feet (10 meters). As another example, the short-range antenna may output signals between about 20-40 feet (6-12 meters). By way of particular example, the short-range antenna is a Bluetooth™ antenna and the controller 2314 may cause the Bluetooth™ antenna to transmit a Bluetooth™ signal, for instance, as a Bluetooth™ beacon signal.

In some examples, the controller 2314 may also cause the wireless communication component(s) 2320 to transmit a request for the computing apparatus 2340a that receives the code 2318 to send the code 2318 and geolocation information 2344 of the computing apparatus 2340a to a certain web address. The certain web address may be a web address of a webpage that may store codes 2318 and geolocation information associated with the codes 2318. The webpage may also store the dates and times 2348, e.g., timestamps, at which the codes 2318 and the geolocation information 2344 were received from computing apparatuses 2340a-2340n.

In examples in which the wireless communication component(s) 2320 transmits a Bluetooth™ beacon signal including the code 2318, the request to send the code 2318 to the certain web address may be included in the beacon signal. In other examples, the controller 2314 may include the request as part of the signal including the code 2318, such as in the header of the IP packets transmitted in the signal. In yet other examples, the controller 2314 may include the request as a separate signal from the signal that includes the code 2318.

One or more of the computing apparatuses 2340a-2340n that are within range of the wearable device 2302 may receive the signal with the code 2318 from the wearable device 2302. In addition, the computing apparatus(es) 2340a-2340n that received the signal may, in response to receipt of the signal, determine geolocation information 2344 of the computing apparatus(es) 2340a-2340n. The geolocation information 2344 may include geographic coordinate data, a place name, or the like, at or near the computing apparatus(es) 2340a-2340n. In some examples, the computing apparatus(es) 2340a-2340n may determine their geolocation information 2344 through use of GPS receivers in the computing apparatus(es) 2340a-2340n. In other examples, the computing apparatus(es) 2340a-2340n may determine their geolocation information 2344 through use of other geolocation techniques, such as triangulation, indoor positioning systems, and/or the like.

The computing apparatus(es) 2340a-2340n may also send the code 2318 and the geolocation information 2344 to the web address identified in the signal. Particularly, the computing apparatus(es) 2340a-2340n may send data 2346, e.g., IP packets, that include the code 2318 and the geolocation information 2344 to the web address. The computing apparatus(es) 2340a-2340n may send the data 2346 to a server 2350 (or multiple servers 2350) that may host the web page corresponding to the web address. In addition, the server 2350 may store the code 2318, the geolocation information 2344, and a date and time 2348 at which the data 2346 was received. The date and time 2348 may be the date and time at which the computing apparatus(es) 2340a-2340n received the code 2318 from the wearable device 2302 or the date and time at which the server 2350 received the data 2346 from the computing apparatus(es) 2340a-2340n.

The computing apparatus(es) 2340a-2340n may send the data 2346 to the server 2350 via a network 160. The network 2360 may be the Internet, a cellular network, and/or the like. In addition, the computing apparatus(es) 2340a-2340n may send the data 2346 immediately or shortly after the computing apparatus(es) 2340a-2340n receive the transmission of the code 2318. In some examples, the computing apparatus(es) 2340a-2340n may not include an identification of the computing apparatus(es) 2340a-2340n in the data 2346 sent to the server 2350. In this regard, the identity of the computing apparatus(es) 2340a-2340n may remain anonymous, which may enhance security by keeping information regarding the computing apparatus(es) 2340a-2340n private.

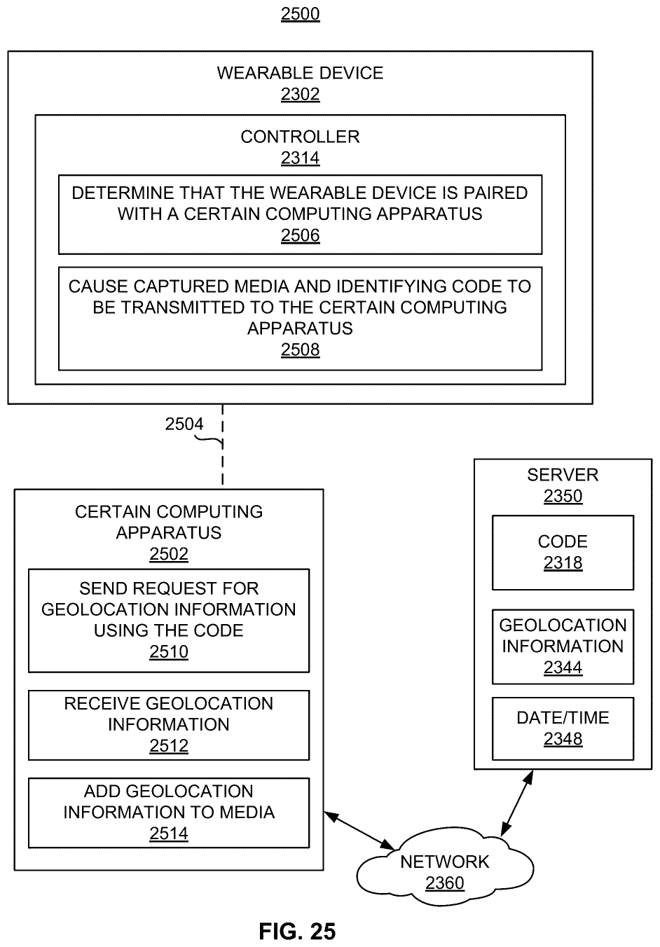

With reference now to FIG. 25, there is shown a block diagram 2500 of a wearable device 2302 and a certain computing apparatus 2502, which may be a computing apparatus 2502 to which the wearable device 2302 may be paired, according to an example. In FIG. 25, the wearable device 2302 may have become paired, as denoted by the dashed line 2504, with the certain computing apparatus 2502 at a time later than when the code 2318 was transmitted to the computing apparatus(es) 2340a-2340n. The certain computing apparatus 2502 may be a computing apparatus that the user of the wearable device 2302 owns or uses, a computing apparatus to which the wearable device 2302 has previously been paired, etc. The pairing with the certain computing apparatus 2502 may be, for instance, a Bluetooth™ pairing, a wired pairing, or another type of pairing.

Following the pairing, the controller 2314 may execute the instructions 2506 to determine that the wearable device 2302 is paired with the certain computing apparatus 2502. In addition, the controller 2314 may execute the instructions 2508 to automatically or in response to receipt of an instruction from a user, transmit the code 2318 to the certain computing apparatus 2502 via a connection related to the pairing. For instance, the controller 2314 may transmit the code 2318 through a Bluetooth™ connection with the certain computing apparatus 2502. The controller 2314 may also cause the media 2306 to be transmitted to the certain computing apparatus 2502 via the Bluetooth™ connection. In other examples, the wearable device 2302 may be physically connected to the certain computing apparatus 2502 via a wire and the controller 2314 may cause the code 2318 and the media 2306 to be communicated to the certain computing apparatus 2502 through the physical connection.

In some examples, the wearable device 2302 may not continuously be paired with the certain computing apparatus 2502, for instance, to conserve battery 2316 life, due to the wearable device 2302 being physically distanced from the certain computing apparatus 2502, etc. As a result, the controller 2314 may not communicate the code 2318 and the media data, e.g., data corresponding to the media 2306, immediately after the media 2306 is captured. Instead, there may be a delay of hours or days in situations, for instance, when the user is remotely located from the certain computing apparatus 2502. As a result, even in instances in which the certain computing apparatus 2502 is equipped with a GPS receiver and is thus able to track its geographic location, the location of the certain computing apparatus 2502 may not correspond to the location of the wearable device 2302 when the media 2306 was captured.

The certain computing apparatus 2502 may include a processor (not shown) that may execute instructions 2510 to send a request, which may include the code 2318, to the server 2350 for the server 2350 to return geolocation information 2344 corresponding to the code 2318. That is, the certain computing apparatus 2502 may send the code 2318 to the server 2350 via the network 2360. In some examples, the certain computing apparatus 2502 may send the date and time for which the geolocation information 2344 is requested. In some examples, the certain computing apparatus 2502 may send the request responsive to receipt of the code 2318 from the wearable device 2302. In some examples, the certain computing apparatus 2502 may send the request periodically, e.g., hourly, daily, or the like.

For instance, the media 2306 corresponding to the code 2318 may include a timestamp of when the media 2306 was captured, such as in the header of the media 2306. The certain computing apparatus 2502 may determine the timestamp and may forward that timestamp to the server 2350. The server 2350 may return the geolocation information 2344 corresponding to the code 2318 that also corresponds to a date and time that is within some predefined time from the date/time 2348 associated with the code 2318 and the geolocation information 2344. In some instances, the server 2350 may have stored multiple geolocation information 2344 associated with the same code 2318. As a result, the date/time 2348 associated with pairs of codes 2318 and geolocation information 2344 may be used to distinguish the geolocation information 2344 for different media 2306.

The server 2350 may identify the geolocation information 2344 associated with the code 2318 and, in some instances, the date/time 2348 associated with the code 2318. For instance, the server 2350 may have stored the code 2318, the geolocation information 2344, and the date/time 2348 in a database and the server 2350 may access the database to identify the geolocation information 2344. In addition, the server 2350 may send the geolocation information 2344 to the certain computing apparatus 2502 and the certain computing apparatus 2502 may execute the instructions 2512 to receive the geolocation information 2344 from the server 2350. The certain computing apparatus 2502 may also execute the instructions 2514 to add the geolocation information to the media 2306, such as by adding the geolocation information 2344 in the metadata for the media 2306. In other words, the certain computing apparatus 2502 may geotag the media 2306.

According to examples, instead of or in addition to the certain computing apparatus 2502 communicating the code 2318 to the server 2350, the wearable device 2302 may communicate the code 2318 to the server 2350. In these examples, the wearable device 2302 may receive the geolocation information 2344 associated with the code 2318 from the server 2350 and may geotag the media 2306 with the geolocation information 2344.

In any of the examples above, by geotagging the media 2306, the locations at which the media 2306 were captured may be identified from data contained in the media 2306. Additionally, the media 2306 may be displayed on a map according to their geolocation information 2344.

In some examples, some of the captured media 2306 may not be assigned a code 2318. In these examples, the geolocation information 2344 of those captured media 2306 may be determined based on the proximities in time of when they were captured with respect to other captured media 2306 that have been assigned codes 2318. That is, once a geolocation information 2344 for a certain media 2306 has been identified, those media 2306 for which geolocation information 2344 may not have been identified from the server 2350 may be assigned the geolocation information 2344 of the media 2306 that was captured most closely in time with those media 2306. The assignment of the geolocation information 2344 for those media 2306 may be based on predefined time thresholds, which may be user-defined, determined based on historical data, etc.

With reference back to FIG. 23, the wearable device 2302 is also depicted as including an input/output interface 2322 through which the wearable device 2302 may receive input signals and may output signals. The input/output interface 2322 may interface with one or more control elements, such as power buttons, volume buttons, a control button, a microphone, the imaging component 2304, and other elements through which a user may perform input actions on the wearable device 2302. A user of the wearable device 2302 may thus control various actions on the wearable device 2302 through interaction with the one or more control elements, through input of voice commands, through use of hand gestures within a field of view of the imaging component 2304, through activation of a control button, etc.

The input/output interface 2322 may also or alternatively interface with an external input/output element 2324. The external input/output element 2324 may be a controller with multiple input buttons, a keyboard, a mouse, a game controller, a glove, a button, a touch screen, or any other suitable device for receiving action requests from users and communicating the received action requests to the wearable device 2302. A user of the wearable device 2302 may control various actions on the wearable device 2302 through interaction with the external input/output element 2324, which may include physical inputs and/or voice command inputs. The controller 2314 may also output signals to the external input/output element 2324 to cause the external input/output element 2324 to provide feedback to the user. The signals may cause the external input/output element 2324 to provide a tactile feedback, such as by vibrating, to provide an audible feedback, to provide a visual feedback on a screen of the external input/output element 2324, etc.

According to examples, a user of the wearable device 2302 may use either of the input/output interface 2322 and the external input/output element 2324 to cause the imaging component 2304 to capture images. In some examples, the controller 2314 may cause the media metadata to be generated when files containing data corresponding to the captured images are stored, for instance, in the data store 2308.

In some examples, the wearable device 2302 may include one or more position sensors 2326 that may generate one or more measurement signals in response to motion of the wearable device 2302. Examples of the one or more position sensors 2326 may include any number of accelerometers, gyroscopes, magnetometers, and/or other motion-detecting or error-correcting sensors, or any combination thereof. In some examples, the wearable device 2302 may include an inertial measurement unit (IMU) 2328, which may be an electronic device that generates fast calibration data based on measurement signals received from the one or more position sensors 2326. The one or more position sensors 2326 may be located external to the IMU 2328, internal to the IMU 2328, or a combination thereof. Based on the one or more measurement signals from the one or more position sensors 2326, the IMU 2328 may generate fast calibration data indicating an estimated position of the wearable device 2302 that may be relative to an initial position of the wearable device 2302. For example, the IMU 2328 may integrate measurement signals received from accelerometers over time to estimate a velocity vector and integrate the velocity vector over time to determine an estimated position of a reference point on the wearable device 2302. Alternatively, the IMU 2328 may provide the sampled measurement signals to the certain computing apparatus 2502, which may determine the fast calibration data.

The wearable device 2302 may also include an eye-tracking unit 2330 that may include one or more eye-tracking systems. As used herein, “eye-tracking” may refer to determining an eye's position or relative position, including orientation, location, and/or gaze of a user's eye. In some examples, an eye-tracking system may include an imaging system that captures one or more images of an eye and may optionally include a light emitter, which may generate light that is directed to an eye such that light reflected by the eye may be captured by the imaging system. In other examples, the eye-tracking unit 2330 may capture reflected radio waves emitted by a miniature radar unit. These data associated with the eye may be used to determine or predict eye position, orientation, movement, location, and/or gaze.

In some examples, the display electronics 2310 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye-tracking unit 2330 may be able to determine where the user is looking or predict any user patterns, etc.

According to examples, the certain computing apparatus 2502 may be a companion console to the wearable device 2302 in that, for instance, the wearable device 2302 may offload some operations to the certain computing apparatus 2502. In other words, the certain computing apparatus 2502 may perform various operations that the wearable device 2302 may be unable to perform or that the wearable device 2302 may be able to perform, but are performed by the certain computing apparatus 2502 to reduce or minimize the load on the wearable device 2302.

According to examples, the certain computing apparatus 2502 is a smartphone, a smartwatch, a tablet computer, a tablet computer, a desktop computer, a server, or the like. The certain computing apparatus 2502 may include a processor and a memory (not shown), which may be a non-transitory computer-readable storage medium storing instructions executable by the processor. The processor may include multiple processing units executing instructions in parallel. The memory may be a hard disk drive, a removable memory, or a solid-state drive (e.g., flash memory or dynamic random access memory (DRAM)).

FIG. 26 illustrates a perspective view of a wearable device 2600, such as a near-eye display device, and particularly, a head-mountable display (HMD) device, according to an example. The HMD device 2600 may include each of the features of the wearable device 2302 discussed herein. In some examples, the HMD device 2600 may be a part of a virtual reality (VR) system, an augmented reality (AR) system, a mixed reality (MR) system, another system that uses displays or wearables, or any combination thereof. In some examples, the HMD device 2600 may include a body 2602 and a head strap 2604. FIG. 26 shows a bottom side 2606, a front side 2608, and a left side 2610 of the body 2602 in the perspective view. In some examples, the head strap 2604 may have an adjustable or extendible length. In particular, in some examples, there may be a sufficient space between the body 2602 and the head strap 2604 of the HMD device 2600 for allowing a user to mount the HMD device 2600 onto the user's head. In some examples, the HMD device 2600 may include additional, fewer, and/or different components. For instance, the HMD device 2600 may include an imaging component 2304 (not shown) in FIG. 26 through which images may be captured as discussed herein.

In some examples, the HMD device 2600 may present, to a user, media or other digital content including virtual and/or augmented views of a physical, real-world environment with computer-generated elements. Examples of the media or digital content presented by the HMD device 2600 may include images (e.g., two-dimensional (2D) or three-dimensional (3D) images), videos (e.g., 2D or 3D videos), audio, or any combination thereof. In some examples, the images and videos may be presented to each eye of a user by one or more display assemblies (not shown in FIG. 26) enclosed in the body 2602 of the HMD device 2600.

In some examples, the HMD device 2600 may include various sensors (not shown), such as depth sensors, motion sensors, position sensors, and/or eye tracking sensors. Some of these sensors may use any number of structured or unstructured light patterns for sensing purposes. In some examples, the HMD device 2600 may include an input/output interface 2322 for communicating with a console, such as the certain computing apparatus 2502, as described with respect to FIG. 25. In some examples, the HMD device 2600 may include a virtual reality engine (not shown), that may execute applications within the HMD device 2600 and receive depth information, position information, acceleration information, velocity information, predicted future positions, or any combination thereof of the HMD device 2600 from the various sensors.

In some examples, the information received by the virtual reality engine may be used for producing a signal (e.g., display instructions) to the one or more display assemblies. In some examples, the HMD device 2600 may include locators (not shown), which may be located in fixed positions on the body 2602 of the HMD device 2600 relative to one another and relative to a reference point. Each of the locators may emit light that is detectable by an external camera. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped liked eyeglasses may be mounted or positioned in a temple arm (i.e., a top far corner of a lens side) of the eyeglasses. It should be appreciated that, in some instances, utilizing a back-mounted projector placement may help to reduce the size or bulkiness of any required housing required for a display system, which may also result in a significant improvement in user experience for a user.

FIG. 27 illustrates a perspective view of a wearable device 2700, such as a wearable eyewear or a near-eye display, in the form of a pair of smartglasses, glasses, or other similar eyewear, according to an example. In some examples, the wearable device 2700 may be a specific implementation of the wearable device 2302 of FIGS. 23-26, and may be configured to operate as a virtual reality display, an augmented reality display, and/or a mixed reality display. In some examples, the wearable device 2700 may be eyewear, in which a user of the wearable device 2700 may see through lenses in the wearable device 2700.

In some examples, the wearable device 2700 may include a frame 2702 and a display 2704. In some examples, the display 2704 may be configured to present media or other content to a user. In some examples, the display 2704 may include display electronics and/or display optics, similar to components described with respect to FIG. 23. For example, the display 2704 may include a liquid crystal display (LCD) display panel, a light-emitting diode (LED) display panel, or an optical display panel (e.g., a waveguide display assembly). In some examples, the display 2704 may also include any number of optical components, such as waveguides, gratings, lenses, mirrors, etc. In other examples, the display 2704 may be omitted and instead, the wearable device 2700 may include lenses that are transparent and/or tinted, such as sunglasses.

In some examples, the wearable device 2700 may further include various sensors 2706a, 2706b, 2706c, 2706d, and 2706e on or within the frame 2702. In some examples, the various sensors 2706a-2706e may include any number of depth sensors, motion sensors, position sensors, inertial sensors, and/or ambient light sensors, as shown. In some examples, the various sensors 2706a-2706e may include any number of image sensors configured to generate image data representing different fields of views in one or more different directions. In some examples, the various sensors 2706a-2706e may be used as input devices to control or influence the displayed content of the wearable device 2700, and/or to provide an interactive virtual reality (VR), augmented reality (AR), and/or mixed reality (MR) experience to a user of the wearable device 2700. In some examples, the various sensors 2706a-2706e may also be used for stereoscopic imaging or other similar application.

In some examples, the wearable device 2700 may further include one or more illuminators 2708 to project light into a physical environment. The projected light may be associated with different frequency bands (e.g., visible light, infra-red light, ultra-violet light, etc.), and may serve various purposes. In some examples, the one or more illuminator(s) 2708 may be used as locators.

In some examples, the wearable device 2700 may also include a camera 2710 or other image capture unit. The camera 2710, which may be equivalent to the imaging component 2304, for instance, may capture images of the physical environment in the field of view of the camera 2710. In some instances, the captured images may be processed, for example, by a virtual reality engine (not shown) to add virtual objects to the captured images or modify physical objects in the captured images, and the processed images may be displayed to the user by the display 2704 for augmented reality (AR) and/or mixed reality (MR) applications. The camera 2710 may also capture media for the media to be geotagged as discussed herein.

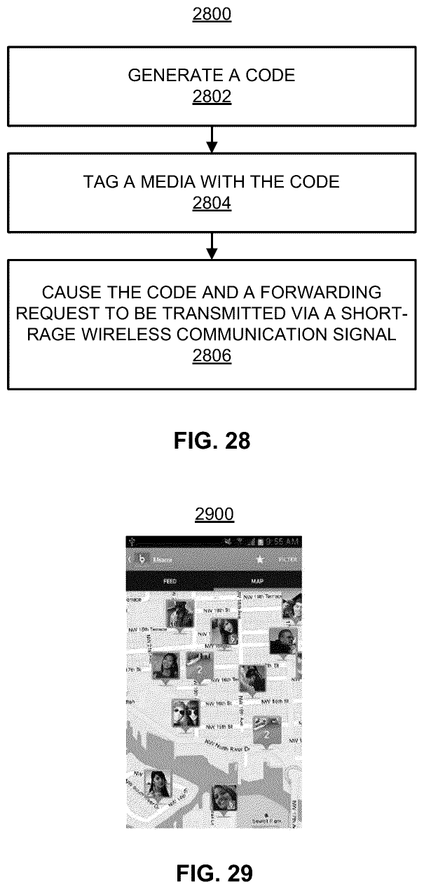

Various manners in which the controller 2314 of the wearable device 2302 may operate are discussed in greater detail with respect to the method 2800 depicted in FIG. 28. FIG. 28 illustrates a flow diagram of a method 2800 for transmitting a code 2318 to be used to identify geolocation information of a media 2306 to an unspecified computing apparatus 2340a, according to an example.

It should be understood that the method 2800 depicted in FIG. 28 may include additional operations and that some of the operations described therein may be removed and/or modified without departing from the scope of the method 2800. The description of the method 2800 is made with reference to the features depicted in FIGS. 23-26 for purposes of illustration.

At block 2802, the controller 2314 may generate a code 2318. The controller 2314 may generate the code 2318 to include characters as discussed herein. Additionally, the controller 2314 may generate the code 2318 prior to or after determining that a media 2306 to be geotagged has been captured.

At block 2804, the controller 2314 may associate a media 2306 with the code 2318. The controller 2314 may associate the media 2306 by embedding the code 2318 into metadata of the media 2306 or through storage of an association between the media 2306 and the code 2318. In some examples, the controller 2314 may generate the code 2318 based on a determination that a user of the wearable device 2302 has instructed the controller 2314 to track the geolocation of the wearable device 2302 when the media 2306 was captured.

At block 2806, the controller 2314 may cause the code 2318 and a forwarding request to be transmitted via a short-range wireless communication signal to an unspecified computing apparatus 2340a. In other words, the controller 2314 may cause the code 2318 and the forwarding request to be broadcasted via the short-range wireless communication signal. By way of example, the controller 2314 may cause the at least one wireless communication component 2320 to transmit the code 2318 and the forwarding request as a Bluetooth™ beacon signal.

As discussed herein, the computing apparatus 2340a that receives the code 2318 and the forwarding request may determine geolocation information 2344 of the computing apparatus 2340a responsive to receipt of the signal. The computing apparatus 2340a may also send the code 2318 and the geolocation information 2344 to a web address identified in the forwarding request. A server 2350 that hosts the web address may receive and store the code 2318 and the geolocation information 2344. The server 2350 may also store a timestamp of when the code 2318 and geolocation information 2344 were received.

At a later time, e.g., after the wearable device 2302 has paired with the certain computing apparatus 2502, the controller 2314 may send the code 2318 to a certain computing apparatus 2502. The certain computing apparatus 2502 may send the code 2318 in a request to the server 2350 for the geolocation information 2344 associated with the code 2318. The server 2350 may identify the geolocation information 2344 associated with the code 2318 and may send the geolocation information 2344 to the certain computing apparatus 2502. The certain computing apparatus 2502 may embed or otherwise associate the geolocation information 2344 with the media 2306 such that the media 2306 may be geotagged with the geolocation information 2344.

In some examples, the geotagging of the media 2306 as described herein may enable media captured at common locations to be identified. In addition, or alternatively, the geotagging of the media 2306 may enable the media 2306 to be displayed in a map according to the geolocations at which the media 2306 were captured. A non-limiting example of a map 2900 including media arranged in the map 2900 according to the locations at which the media 2306 were captured is illustrated in FIG. 29.

Some or all of the operations set forth in the method 2800 may be included as a utility, program, or subprogram, in any desired computer accessible medium. In addition, the method 2800 may be embodied by a computer program, which may exist in a variety of forms both active and inactive. For example, they may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

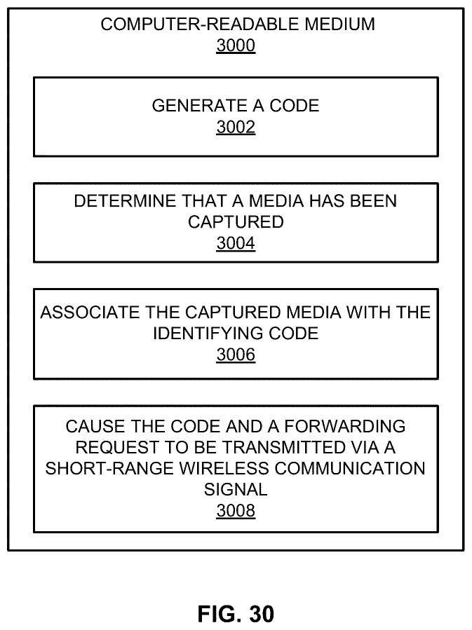

Turning now to FIG. 30, there is illustrated a block diagram of a computer-readable medium 3000 that has stored thereon computer-readable instructions for transmitting a code and a forwarding request via a short-range wireless communication signal to an unspecified computing apparatus to enable a media to be geotagged, according to an example. It should be understood that the computer-readable medium 3000 depicted in FIG. 30 may include additional instructions and that some of the instructions described herein may be removed and/or modified without departing from the scope of the computer-readable medium 3000 disclosed herein. In some examples, the computer-readable medium 3000 is a non-transitory computer-readable medium, in which the term “non-transitory” does not encompass transitory propagating signals.

The computer-readable medium 3000 may have stored thereon computer-readable instructions 3002-3008 that a controller, such as the controller 2314 of the wearable device 2302 depicted in FIGS. 23-26 may execute. The computer-readable medium 3000 is an electronic, magnetic, optical, or other physical storage device that contains or stores executable instructions. The computer-readable medium 3000 is, for example, Random Access memory (RAM), an Electrically Erasable Programmable Read-Only Memory (EEPROM), a storage device, or an optical disc.

The controller may execute the instructions 3002 to generate a code 2318. The controller may execute the instructions 3004 to determine that the imaging component 2304 has captured a media 2306. The controller may execute the instructions 3006 to associate the captured media 2306 with the code 2318. In addition, the controller may execute the instructions 3008 to cause the code 2318 and a forwarding request to be transmitted via a short-range wireless communication signal.

It should be noted that the functionality described herein may be subject to one or more privacy policies, described below, enforced by the apparatuses and methods described herein that may bar use of images for concept detection, recommendation, generation, and analysis.

In particular examples, one or more elements (e.g., content or other types of elements) of a computing system may be associated with one or more privacy settings. The one or more elements may be stored on or otherwise associated with any suitable computing system or application, such as, for example, the wearable device 2302, 2600, 2700, a social-networking application, a messaging application, a photo-sharing application, or any other suitable computing system or application. Privacy settings (or “access settings”) for an element may be stored in any suitable manner, such as, for example, in association with the element, in an index on an authorization server, in another suitable manner, or any suitable combination thereof. A privacy setting for an element may specify how the element (or particular information associated with the element) can be accessed, stored, or otherwise used (e.g., viewed, shared, modified, copied, executed, surfaced, or identified) within the online social network. When privacy settings for an element allow a particular user or other entity to access that element, the element may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an element may specify a “blocked list” of users or other entities that should not be allowed to access certain information associated with the element. In particular examples, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the wearable device 2302, 2600, 2700, the certain computing apparatus 2502, or shared with other systems (e.g., an external system). Although this disclosure describes using particular privacy settings in a particular manner, this disclosure contemplates using any suitable privacy settings in any suitable manner.

In particular examples, the wearable device 2302, 2600, 2700 and/or the certain computing apparatus 2502 may present a “privacy wizard” (e.g., within a webpage, a module, one or more dialog boxes, or any other suitable interface) to a user to assist the user in specifying one or more privacy settings. The privacy wizard may display instructions, suitable privacy-related information, current privacy settings, one or more input fields for accepting one or more inputs from the user specifying a change or confirmation of privacy settings, or any suitable combination thereof. In particular examples, the wearable device 2302, 2600, 2700 and/or the certain computing apparatus 2502 may offer a “dashboard” functionality to the user that may display, to the user, current privacy settings of the user. The dashboard functionality may be displayed to the user at any appropriate time (e.g., following an input from the user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an element may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different elements of the same type associated with a user may have different privacy settings. Different types of elements associated with a user may have different types of privacy settings. As an example and not by way of limitation, a user may specify that the user's status updates are public, but any images shared by the user are visible only to the user's friends on the online social network. As another example and not by way of limitation, a user may specify different privacy settings for different types of entities, such as individual users, friends-of-friends, followers, user groups, or corporate entities. As another example and not by way of limitation, a user may specify a group of users that may view videos posted by the user, while keeping the videos from being visible to the user's employer. In particular examples, different privacy settings may be provided for different user groups or user demographics. As an example and not by way of limitation, a user may specify that other users who attend the same university as the user may view the user's pictures, but that other users who are family members of the user may not view those same pictures.

In particular examples, the wearable device 2302, 2600, 2700 and/or the certain computing apparatus 2502 may provide one or more default privacy settings for each element of a particular element-type. A privacy setting for an element that is set to a default may be changed by a user associated with that element. As an example and not by way of limitation, all images posted by a user may have a default privacy setting of being visible only to friends of the user and, for a particular image, the user may change the privacy setting for the image to be visible to friends and friends-of-friends.

In particular examples, privacy settings may allow a user to specify (e.g., by opting out, by not opting in) whether the wearable device 2302, 2600, 2700 and/or the certain computing apparatus 2502 may receive, collect, log, or store particular elements or information associated with the user for any purpose. In particular examples, privacy settings may allow the user to specify whether particular applications or processes may access, store, or use particular elements or information associated with the user. The privacy settings may allow the user to opt in or opt out of having elements or information accessed, stored, or used by specific applications or processes. The wearable device 2302, 2600, 2700 and/or the certain computing apparatus 2502 may access such information in order to provide a particular function or service to the user, without the wearable device 2302, 2600, 2700 and/or the certain computing apparatus 2502 having access to that information for any other purposes. Before accessing, storing, or using such elements or information, the wearable device 2302, 2600, 2700 and/or the certain computing apparatus 2502 may prompt the user to provide privacy settings specifying which applications or processes, if any, may access, store, or use the elements or information prior to allowing any such action. As an example and not by way of limitation, a user may transmit a message to a second user via an application related to the online social network (e.g., a messaging app), and may specify privacy settings that such messages should not be stored by the wearable device 2302, 2600, 2700 and/or the certain computing apparatus 2502.

In particular examples, a user may specify whether particular types of elements or information associated with the first user may be accessed, stored, or used by the wearable device 2302, 2600, 2700 and/or the certain computing apparatus 2502. As an example and not by way of limitation, the user may specify that images sent by the user through the wearable device 2302, 2600, 2700 and/or the certain computing apparatus 2502 may not be stored by the wearable device 2302, 2600, 2700 and/or the certain computing apparatus 2502. As another example and not by way of limitation, a user may specify that messages sent from the user to a particular second user may not be stored by the wearable device 2302, 2600, 2700 and/or the certain computing apparatus 2502. As yet another example and not by way of limitation, a user may specify that all elements sent via a particular application may be saved by the wearable device 2302, 2600, 2700 and/or the certain computing apparatus 2502.

In particular examples, privacy settings may allow a user to specify whether particular elements or information associated with the user may be accessed from client devices or external systems. The privacy settings may allow the user to opt in or opt out of having elements or information accessed from a particular device (e.g., the phone book on a user's smart phone), from a particular application (e.g., a messaging app), or from a particular system (e.g., an email server). The wearable device 2302, 2600, 2700 and/or the certain computing apparatus 2502 may provide default privacy settings with respect to each device, system, or application, and/or the user may be prompted to specify a particular privacy setting for each context. As an example and not by way of limitation, the user may utilize a location-services feature of the wearable device 2302, 2600, 2700 and/or the certain computing apparatus 2502 to provide recommendations for restaurants or other places in proximity to the user. The user's default privacy settings may specify that the wearable device 2302, 2600, 2700 and/or the certain computing apparatus 2502 may use location information provided from a client device of the user to provide the location-based services, but that the wearable device 2302, 2600, 2700 and/or the certain computing apparatus 2502 may not store the location information of the user or provide it to any external system. The user may then update the privacy settings to allow location information to be used by a third-party image-sharing application in order to geotag photos.

In particular examples, privacy settings may allow a user to engage in the ephemeral sharing of elements on the online social network. Ephemeral sharing refers to the sharing of elements (e.g., posts, photos) or information for a finite period of time. Access or denial of access to the elements or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In particular examples, for particular objects or information having privacy settings specifying that they are ephemeral, the wearable device 2302, 2600, 2700 and/or the certain computing apparatus 2502 may be restricted in its access, storage, or use of the elements or information. The wearable device 2302, 2600, 2700 and/or the certain computing apparatus 2502 may temporarily access, store, or use these particular elements or information in order to facilitate particular actions of a user associated with the elements or information, and may subsequently delete the elements or information, as specified by the respective privacy settings. As an example and not by way of limitation, a user may transmit a message to a second user, and the wearable device 2302, 2600, 2700 and/or the certain computing apparatus 2502 may temporarily store the message in a content data store until the second user has viewed or downloaded the message, at which point the wearable device 2302, 2600, 2700 and/or the certain computing apparatus 2502 may delete the message from the data store. As another example and not by way of limitation, continuing with the prior example, the message may be stored for a specified period of time (e.g., 2 weeks), after which point the wearable device 2302, 2600, 2700 and/or the certain computing apparatus 2502 may delete the message from the content data store.

In particular examples, privacy settings may allow a user to specify one or more geographic locations from which elements can be accessed. Access or denial of access to the elements may depend on the geographic location of a user who is attempting to access the objects. As an example and not by way of limitation, a user may share an element and specify that only users in the same city may access or view the element. As another example and not by way of limitation, a first user may share an element and specify that the element is visible to second users only while the user is in a particular location. If the user leaves the particular location, the element may no longer be visible to the second users. As another example and not by way of limitation, a user may specify that an element is visible only to second users within a threshold distance from the user. If the user subsequently changes location, the original second users with access to the element may lose access, while a new group of second users may gain access as they come within the threshold distance of the user.

In particular examples, the wearable device 2302, 2600, 2700 and/or the certain computing apparatus 2502 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the wearable device 2302, 2600, 2700 and/or the certain computing apparatus 2502. The user's privacy settings may specify that such information may be used only for particular processes, such as authentication, and further specify that such information may not be shared with any external system or used for other processes or applications associated with the wearable device 2302, 2600, 2700 and/or the certain computing apparatus 2502. As another example and not by way of limitation, the wearable device 2302, 2600, 2700 and/or the certain computing apparatus 2502 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any external system or used by other processes or applications associated with the wearable device 2302, 2600, 2700 and/or the certain computing apparatus 2502. As another example and not by way of limitation, the wearable device 2302, 2600, 2700 and/or the certain computing apparatus 2502 may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any external system or used by other processes or applications associated with the wearable device 2302, 2600, 2700 and/or the certain computing apparatus 2502.

In particular examples, changes to privacy settings may take effect retroactively, affecting the visibility of elements and content shared prior to the change. As an example and not by way of limitation, a user may share a first image and specify that the first image is to be public to all other users. At a later time, the user may specify that any images shared by the user should be made visible only to a user group. The wearable device 2302, 2600, 2700 and/or the certain computing apparatus 2502 may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the wearable device 2302, 2600, 2700 and/or the certain computing apparatus 2502 may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the wearable device 2302, 2600, 2700 and/or the certain computing apparatus 2502 may determine that a user may want to change one or more privacy settings in response to a trigger action associated with the user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the wearable device 2302, 2600, 2700 and/or the certain computing apparatus 2502 may prompt the user to change the privacy settings regarding the visibility of elements associated with the user. The prompt may redirect the user to a workflow process for editing privacy settings with respect to one or more entities associated with the trigger action. The privacy settings associated with the user may be changed only in response to an explicit input from the user, and may not be changed without the approval of the user. As an example and not byway of limitation, the workflow process may include providing the user with the current privacy settings with respect to the second user or to a group of users (e.g., un-tagging the user or second user from particular objects, changing the visibility of particular objects with respect to the second user or group of users), and receiving an indication from the user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the wearable device 2302, 2600, 2700 and/or the certain computing apparatus 2502 may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the wearable device 2302, 2600, 2700 and/or the certain computing apparatus 2502 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the wearable device 2302, 2600, 2700 and/or the certain computing apparatus 2502 may send a reminder to the user to confirm his or her privacy settings every six months or after every ten photo posts. In particular examples, privacy settings may also allow users to control access to the objects or information on a per-request basis. As an example and not by way of limitation, the wearable device 2302, 2600, 2700 and/or the certain computing apparatus 2502 may notify the user whenever an external system attempts to access information associated with the user, and require the user to provide verification that access should be allowed before proceeding.

In some examples, a wearable device may include an imaging component to capture media, at least one wireless communication component, and a controller to determine that the imaging component has captured a media, associate the captured media with a code to be used to geotag the media, and cause the at least one wireless communication component, based on the determination that the imaging component has captured a media, to wirelessly transmit the code to an unspecified computing apparatus, wherein the unspecified computing apparatus is to associate the code with geolocation information of the unspecified computing apparatus and send the code and the geolocation information to a server, wherein the associated geolocation information is to be accessed from the server utilizing the code and used to geotag the media.

The controller may generate the code based on the determination that the imaging component has captured the media. The at least one wireless communication component may include a short-range antenna to transmit the code as a short-range signal. The controller may also cause the at least one wireless communication component to transmit the code to an unspecified computing apparatus to which the wearable device is unpaired. The controller may determine that the wearable device is paired with a certain computing apparatus and transmit the code to the certain computing apparatus via a connection related to the pairing, wherein the certain computing apparatus is to request geolocation information from the server using the code.

The controller may transmit a request for the unspecified computing apparatus to send the code and geolocation information of the unspecified computing apparatus to the server, wherein the server is to store the code, the geolocation information of the unspecified computing apparatus, and a date and time at which the server received the code and geolocation of the unspecified computing apparatus. The controller may determine that a user has instructed the controller to track a location at which the media has been captured and cause the at least one wireless communication component to transmit the code based on a determination that the user has instructed the controller to track the location at which the media has been captured. The wearable device may include a wearable eyewear.

A wearable eyewear may include an imaging component to capture media, at least one wireless communication component, and a controller to generate a code, determine that the imaging component has captured a media, associate the captured media with the code, in which the code is to be used to geotag the captured media, and cause the at least one wireless communication component to transmit the code and a forwarding request via a short-range wireless communication signal to an unspecified computing apparatus based on the determination that the imaging component has captured the media, wherein the forwarding request is a request for the unspecified computing apparatus that receives the code to send the code and geolocation information of the computing apparatus to a certain web address, wherein the geolocation information is to be accessed from a server that hosts the certain web address utilizing the code and used to geotag the media.

The controller may generate the code prior to determining that the imaging component has captured the media. The controller may generate the code following the determination that the imaging component has captured the media. The at least one wireless communication component may include a Bluetooth antenna to transmit the code and the forwarding request as a Bluetooth signal. The controller may cause the at least one wireless communication component to transmit the code and the forwarding request to an unspecified computing apparatus to which the wearable eyewear is unpaired. The controller may determine that the wearable eyewear is paired with a certain computing apparatus and may transmit the captured media tagged with the code to the certain computing apparatus, wherein the certain computing apparatus is to request geolocation information from a server associated with the certain web address using the code. The controller may determine that a user has instructed the controller to track a location at which the media has been captured and based on a determination that the user has instructed the controller to track the location at which the media has been captured, cause the at least one wireless communication component to transmit the code.

A method may include generating, by a controller of a wearable device, a code, associating, by the controller, a media with the code, and causing, by the controller, at least one wireless communication component to transmit the code and a forwarding request via a short-range wireless communication signal to an unspecified computing apparatus, wherein the forwarding request is a request for the unspecified computing apparatus that receives the code to send the code and geolocation information of the computing apparatus to a certain web address, wherein the geolocation information is to be accessed from a server that hosts the certain web address utilizing the code and used to geotag the media.

The method may also include generating the code prior to determining that the media has been captured. The method may also include determining that the media has been captured and generating the code following the determination that the media has been captured. The method may also include causing the at least one wireless communication component to transmit the code and the forwarding request as a Bluetooth beacon signals. The method may further include determining that a user has instructed the controller to track a location at which the media has been captured and based on a determination that the user has instructed the controller to track the location at which the media has been captured, causing the at least one wireless communication component to transmit the code.

In the foregoing description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A computing system, comprising:
a processor; and
a memory on which is stored machine-readable instructions that when executed by the processor, cause the processor to:
use an optical propagation model and perceptual loss function to match an output of a spatial light modulator (SLM) based holographic display to that of a target image, wherein an input illumination into the SLM includes three simultaneous human-visible wavelengths of light.

2. The computing system of claim 1, wherein the instructions cause the processor to, simultaneously:
cause a first illumination source to output light at a first human-visible wavelength onto the SLM;
cause a second illumination source to output light at a second human-visible wavelength onto the SLM; and
cause a third illumination source to output light at a third human-visible wavelength onto the SLM.

3. The computing system of claim 2, wherein the instructions cause the processor to cause the SLM to modulate the three human-visible wavelengths of light received from the first illumination source, the second illumination source, and the third illumination source to be modulated by a same set of pixels in the SLM, wherein the pixels perturb the three human-visible wavelengths of light in different manners according to their respective wavelengths.

4. The computing system of claim 3, wherein the instructions cause the processor to:
use the optical propagation model and the perceptual loss function to find a driving pattern for the SLM that distributes error due to the modulation of the three human-visible wavelengths of light by the same set of pixels in the SLM.

5. The computing system of claim 4, wherein the instructions cause the processor to:
find the driving pattern that minimizes an impact of the error on a perceptual quality of an image generated by the SLM relative to a target image.

6. A method, comprising:
using, by a processor, an optical propagation model and perceptual loss function to match an output of a spatial light modulator (SLM) based holographic display to that of a target image, wherein an input illumination into the SLM includes three simultaneous human-visible wavelengths of light.

7. The method of claim 6, further comprising:
simultaneously causing, by the processor:
a first illumination source to output light at a first human-visible wavelength onto the SLM;
a second illumination source to output light at a second human-visible wavelength onto the SLM; and
a third illumination source to output light at a third human-visible wavelength onto the SLM.

8. The method of claim 7, further comprising:
causing the SLM to modulate the three human-visible wavelengths of light received from the first illumination source, the second illumination source, and the third illumination source to be modulated by a same set of pixels in the SLM, wherein the pixels perturb the three human-visible wavelengths of light in different manners according to their respective wavelengths.

9. The method of claim 8, further comprising:
using the optical propagation model and the perceptual loss function to find a driving pattern for the SLM that distributes error due to the modulation of the three human-visible wavelengths of light by the same set of pixels in the SLM.

10. The method of claim 9, further comprising:
finding the driving pattern that minimizes an impact of the error on a perceptual quality of an image generated by the SLM relative to a target image.

11. A non-transitory computer-readable storage medium having an executable stored thereon, which when executed instructs a processor to:
use an optical propagation model and perceptual loss function to match an output of a spatial light modulator (SLM) based holographic display to that of a target image, wherein an input illumination into the SLM includes three simultaneous human-visible wavelengths of light.

12. The non-transitory computer-readable storage medium of claim 11, wherein the instructions further cause the processor to:
simultaneously cause:
a first illumination source to output light at a first human-visible wavelength onto the SLM;
a second illumination source to output light at a second human-visible wavelength onto the SLM; and
a third illumination source to output light at a third human-visible wavelength onto the SLM.

13. The non-transitory computer-readable storage medium of claim 12, wherein the instructions further cause the processor to:
cause the SLM to modulate the three human-visible wavelengths of light received from the first illumination source, the second illumination source, and the third illumination source to be modulated by a same set of pixels in the SLM, wherein the pixels perturb the three human-visible wavelengths of light in different manners according to their respective wavelengths.

14. The non-transitory computer-readable storage medium of claim 13, wherein the instructions further cause the processor to:
use the optical propagation model and the perceptual loss function to find a driving pattern for the SLM that distributes error due to the modulation of the three human-visible wavelengths of light by the same set of pixels in the SLM.

15. The non-transitory computer-readable storage medium of claim 11, wherein the instructions further cause the processor to:
find the driving pattern that minimizes an impact of the error on a perceptual quality of an image generated by the SLM relative to a target image.
